(19) United States
(12) Patent Application Publication
(10) Pub. No.: US 2019/0003394 A1
(43) Pub. Date: Jan. 3, 2019

(54) GAS TURBINE COOLING SYSTEM, GAS TURBINE FACILITY INCLUDING THE SAME, AND CONTROL METHOD OF GAS TURBINE COOLING SYSTEM

(71) Applicant: Mitsubishi Hitachi Power Systems, Ltd., Kanagawa (JP)

(72) Inventors: Satoko FUJII, Yokohama-shi (JP); Tetsuya YABE, Yokohama-shi (JP); Kazuya HIGASHI, Yokohama-shi (JP)

(21) Appl. No.: 16/063,461

(22) PCT Filed: Jan. 11, 2017
(86) PCT No.: PCT/JP2017/000599

§ 371 Date: Jun. 18, 2018

(30) Foreign Application Priority Data
Jan. 22, 2016 (JP) 2016-010765

(51) Int. Cl. F02C 7/18; F01D 17/14; F01D 25/12; F02C 6/08; F02C 9/18

(52) U.S. Cl. CPC F02C 7/18; F01D 17/145; F05D 2260/20; F02C 6/08; F02C 9/18; F01D 25/12

(57) ABSTRACT

A gas turbine cooling system includes: a cooling air line that guides compressed air compressed by an air compressor to a hot part; a cooler that cools the compressed air in the cooling air line; a return line that returns cooling air in the cooling air line to an upstream side in the cooling air line; a return valve that adjusts the flow rate of the cooling air flowing through the return line; and a control device that controls the degree of opening of the return valve. The control device has a second valve command generation section that, when a reception unit receives a load rejection command, generates as a second valve command a valve command ordering the degree of opening of the return valve to be forcedly increased to a predetermined load rejection-adapted degree of opening.

### TECHNICAL FIELD

The present invention relates to a gas turbine cooling system that cools hot parts coming in contact with combustion gas in a gas turbine, a gas turbine facility including this gas turbine cooling system, and a control method of a gas turbine cooling system.

The present application claims priority based on Japanese Patent Application No. 2016-010765 filed in Japan on Jan. 22, 2016, the contents of which are incorporated herein by reference.

### BACKGROUND ART

A gas turbine includes an air compressor that generates compressed air by compressing outside air, a combustor that generates combustion gas by combusting fuel in the compressed air, and a turbine that is driven by the combustion gas. In the gas turbine, a combustion liner of the combustor, blades and vanes of the turbine, etc. are exposed to the high-temperature combustion gas, and it is therefore necessary to cool these hot parts so as to protect them from the heat of the combustion gas.

Patent Literature 1 below discloses a cooling system for cooling a combustion liner of a combustor that is one of the hot parts of a gas turbine. This cooling system includes a cooling air line that guides compressed air compressed by an air compressor of the gas turbine to the combustion liner, a cooler that cools the compressed air in the cooling air line to produce cooling air, and a booster that pressurizes the cooling air in the cooling air line.

### CITATION LIST

### Patent Literature

Patent Literature 1: Japanese Patent Laid-Open No. 2014-070510

### SUMMARY OF INVENTION

### Technical Problem

In the event of a load rejection of a gas turbine, the operation state of the gas turbine changes rapidly. However, the technique described in Patent Literature 1 does not take into account how to respond to a load rejection.

Therefore, the present invention aims to provide a gas turbine cooling system that can cool a hot part even in the event of a load rejection, a gas turbine facility including this gas turbine cooling system, and a control method of a gas turbine cooling system.

### Solution to Problem

A gas turbine cooling system as an aspect of the present invention to achieve the above object includes: a cooling air line that guides compressed air compressed by an air compressor of a gas turbine to a hot part coming in contact with combustion gas in the gas turbine; a cooler that cools the compressed air in the cooling air line to produce cooling air; a booster that pressurizes the cooling air in the cooling air line; a return line that returns the cooling air in a discharge line that is a line of the cooling air line located on the side of the hot part from the booster, to an intake air line that is a line of the cooling air line located on the side of the air compressor from the booster; a return valve that is provided in the return line and adjusts the flow rate of the cooling air flowing through the return line; a detector that detects a state amount of the cooling air flowing through the intake air line and a state amount of the cooling air flowing through the discharge line; and a control device that controls the degree of opening of the return valve.

The control device includes: a reception unit that receives a load rejection command indicating a load rejection of the gas turbine; a first valve command generation section that generates a first valve command indicating a degree of opening of the return valve according to the state amount detected by the detector; a second valve command generation section that, when the reception unit receives the load rejection command, generates as a second valve command a valve command ordering the degree of opening of the return valve to be forcedly increased to a predetermined load rejection-adapted degree of opening, regardless of the state amount detected by the detector; and a return valve command output unit that outputs a return valve command based on the second valve command to the return valve when the second valve command generation section is generating the second valve command, and outputs a return valve command based on the first valve command according to a state of the gas turbine to the return valve when the second valve command generation section is not generating the second valve command.

In the event of a load rejection, the discharge pressure of the air compressor decreases rapidly. The intake pressure of the booster in the cooling system also decreases rapidly as the discharge pressure of the air compressor decreases rapidly. Due to the presence of the cooling air line etc., the discharge pressure of the booster decreases with a delay after the decrease in the discharge pressure of the air compressor. Accordingly, the pressure ratio in the booster temporarily increases immediately after a load rejection. Thus, in the event of a load rejection, the likelihood of surging in the booster increases rapidly.

In this cooling system, the second valve command generation section generates the second valve command when the reception unit receives the load rejection command. This second valve command is a valve command ordering the degree of opening of the return valve to be forcedly increased to the predetermined load rejection-adapted degree of opening, regardless of the state amount detected by the detector. When the second valve command generation section generates the second valve command, the return valve command output unit outputs a return valve command based on this second valve command to the return valve. As a result, the degree of opening of the return valve is forcedly increased to the load rejection-adapted degree of opening immediately after a load rejection.

When the degree of opening of the return valve increases, the flow rate of the cooling air flowing through the return line increases, so that the volume flow rate of the cooling air flowing through the booster increases. Thus, when the degree of opening of the return valve increases, the suction volume flow rate in the booster increases. Moreover, when the degree of opening of the return valve increases, the difference between the discharge pressure and the intake pressure of the booster decreases, so that the pressure ratio in the booster decreases. Therefore, when the degree of opening of the return valve increases, the likelihood of surging decreases.

Thus, this cooling system can reduce the likelihood of surging in the booster in the event of a load rejection. Accordingly, this cooling system can send cooling air to the hot part and cool this hot part even in the event of a load rejection.

In the above gas turbine cooling system, the load rejection-adapted degree of opening may be a degree of opening at which the return valve is fully open.

In this cooling system, the load rej ection-adapted degree of opening is a degree of opening at which the return valve is fully open. Accordingly, the degree of opening of the return valve is set to full opening immediately after a load rejection. As a result, the flow rate of the cooling air flowing through the return line increases, and the likelihood of surging in the booster in the event of a load rejection can be further reduced.

In any one of the above gas turbine cooling systems, when the reception unit receives the load rejection command, the second valve command generation section may generate as the second valve command a valve command ordering the load rejection-adapted degree of opening to be maintained until a predetermined condition under which the likelihood of surging in the booster is assumed to have become low is met.

In this cooling system, the degree of opening of the return valve is maintained at the load rejection-adapted degree of opening until the condition under which the likelihood of surging in the booster is assumed to have become low is met.

In the above gas turbine cooling system in which a valve command ordering the load rejection-adapted degree of opening to be maintained until the condition is met is generated as the second valve command, when the predetermined condition is met, the second valve command generation section may generate as the second valve command a valve command ordering the degree of opening of the return valve to be reduced from the load rej ection-adapted degree of opening.

Even when the degree of opening of the return valve is set to the load rejection-adapted degree of opening, the cooling air is supplied from the booster to the hot part through the discharge line. However, when the degree of opening of the return valve is set to the load rejection-adapted degree of opening, the flow rate of the cooling air supplied to the hot part decreases since part of the cooling air discharged from the booster passes through the return valve. This may result in burn damage to the hot part.

In this cooling system, however, the degree of opening of the return valve is reduced when the condition under which the likelihood of surging in the booster is assumed to have become low is met after the load rejection command is received. As a result, the flow rate of the cooling air supplied from the booster to the hot part through the discharge line increases, so that burn damage to the hot part can be suppressed.

In the above gas turbine cooling system in which, when the condition is met, a valve command ordering the degree of opening of the return valve to be reduced from the load rejection-adapted degree of opening is generated as the second valve command, the first valve command generation section may generate the first valve command indicating an increasing degree of opening of the return valve when the state amount detected by the detector indicates that the likelihood of surging is increasing, and may generate the first valve command indicating a decreasing degree of opening of the return valve when the state amount detected by the detector indicates that the likelihood of surging is decreasing; and a rate of change in a closing direction of the degree of opening indicated by the second valve command when the predetermined condition is met may be higher than a maximum rate of change in the closing direction of the degree of opening indicated by the first valve command when the likelihood of surging is decreasing.

In this cooling system, the degree of opening of the return valve decreases rapidly when the condition under which the likelihood of surging in the booster is assumed to have become low is met after the load rejection command is received. As a result, the flow rate of the cooling air supplied from the booster to the hot part through the discharge line increases rapidly, so that burn damage to the hot part can be further suppressed.

In the above gas turbine cooling system in which, when the condition is met, a valve command ordering the degree of opening of the return valve to be reduced from the load rejection-adapted degree of opening is generated as the second valve command, the rate of change in the degree of opening indicated by the second valve command when the predetermined condition is met may be a predetermined rate of change.

In the above gas turbine cooling system in which, when the condition is met, a valve command ordering the degree of opening of the return valve to be reduced from the load rejection-adapted degree of opening is generated as the second valve command, when the predetermined condition is met, the second valve command generation section may generate as the second valve command a valve command indicating a degree of opening that is determined according to the state amount detected by the detector.

In any one of the above gas turbine cooling systems in which, when the condition is met, a valve command ordering the degree of opening of the return valve to be reduced from the load rej ection-adapted degree of opening is generated as the second valve command, the second valve command generation section may stop generating the second valve command when a second condition is met after a first condition that is the predetermined condition is met.

In this cooling system, a return valve command based on the first valve command is output to the return valve when the second condition is met.

Any one of the above gas turbine cooling systems may further include an intake valve that is provided in the intake air line and adjusts the flow rate of the cooling air flowing through the intake air line, and the control device may include: an intake valve command generation unit that, when the reception unit receives the load rejection command, generates a first valve command ordering the degree of opening of the intake valve to be forcedly increased to a predetermined load rejection-adapted degree of opening, regardless of the state amount detected by the detector; and an intake valve command output unit that outputs, to the intake valve, an intake valve command based on the first valve command generated by the intake valve command generation unit.

In this cooling system, when the reception unit receives the load rejection command, the intake valve command output unit outputs, to the intake valve, an intake valve command ordering the degree of opening of the intake valve to be forcedly increased to the predetermined load rejection-adapted degree of opening. Thus, in this cooling system, the degree of opening of the intake valve is forcedly increased to the load rejection-adapted degree of opening immediately after a load rejection. When the degree of opening of the intake valve increases, the volume flow rate of the cooling air flowing through the booster increases. Therefore, this cooling system can reduce the likelihood of surging in the event of a load rejection also by this action of the intake valve. Moreover, this cooling system can suppress burn damage to the hot part, since the volume flow rate of the cooling air flowing through the booster increases, and the volume flow rate of the cooling air supplied to the hot part through the discharge line also increases, as the degree of opening of the intake valve increases. In particular, in this cooling system, a decrease in the flow rate of the cooling air supplied to the hot part due to the return valve being set to the load rejection-adapted degree of opening can be offset by forcedly opening the intake valve.

In the above gas turbine cooling system including the intake valve, the load rejection-adapted degree of opening indicated by the first valve command generated by the intake valve command generation unit may be a degree of opening at which the intake valve is fully open.

In this cooling system, the load rej ection-adapted degree of opening is a degree of opening at which the intake valve is fully open. Accordingly, the degree of opening of the intake valve is set to full opening immediately after a load rejection. Thus, the volume flow rate of the cooling air flowing through the booster increases, and the volume flow rate of the cooling air supplied to the hot part through the discharge line also increases, so that this cooling system can cool the hot part while reducing the likelihood of surging in the booster in the event of a load rejection.

In any one of the above gas turbine cooling systems, the control device may include a reference command generation unit that generates a reference command indicating a degree of opening that changes with a positive correlation with a change in a load applied to the gas turbine; when the likelihood of surging in the booster has become high, the first valve command generation section may generate as the first valve command a command indicating a degree of opening that is larger than the degree of opening indicated by the reference command, according to the state amount detected by the detector; the return valve command output unit may have a selection section that selects one command of the first valve command, the second valve command, and the reference command related to the return valve, and a command conversion section that converts the one command selected by the selection section into a return valve command suitable for controlling the return valve and outputs the return valve command to the return valve; when the second valve command, and the first valve command or the reference command related to the return valve, are input, the selection section may select the second valve command, and when the second valve command is not input and the first valve command and the reference command are input, the selection section may select one of the commands indicating a larger degree of opening; and in a case where the one command selected by the selection section is the reference command, when the load is smaller than a predetermined value, the command conversion section may convert the reference command into a return valve command indicating a degree of opening of the return valve that changes with a negative correlation with a change in the load, and when the load is not smaller than the predetermined value, the command conversion section may convert the reference command into a return valve command indicating a degree of opening that is constant regardless of a change in the load.

In this gas turbine cooling system, the degree of opening of the return valve decreases gradually as the load increases, when the load is smaller than the predetermined value and the return valve command output unit outputs a return valve command based on the reference command. When the degree of opening of the return valve decreases, the flow rate of the cooling air flowing through the return line decreases, so that the flow rate of the cooling air sent to the hot part increases. Thus, in this case, the return valve can be controlled so as to increase the flow rate of the cooling air sent to the hot part as the load increases.

In any one of the above gas turbine cooling systems including the intake valve, the control device may include a reference command generation unit that generates a reference command indicating a degree of opening that changes with a positive correlation with a change in a load applied to the gas turbine; when the likelihood of surging in the booster has become high, the first valve command generation section may generate as the first valve command a command indicating a degree of opening that is larger than the degree of opening indicated by the reference command, according to the state amount detected by the detector; the return valve command output unit may have a selection section that selects one command of the first valve command, the second valve command, and the reference command related to the return valve, and a command conversion section that converts the one command selected by the selection section into a return valve command suitable for controlling the return valve and outputs the return valve command to the return valve; when the second valve command related to the return valve and the first valve command or the reference command related to the return valve are input, the selection section may select the second valve command, and when the second valve command is not input and the first valve command and the reference command are input, the selection section may select one of the commands indicating a larger degree of opening; in a case where the one command selected by the selection section is the reference command, when the load is smaller than a predetermined value, the command conversion section may convert the reference command into a return valve command indicating a degree of opening of the return valve that changes with a negative correlation with a change in the load, and when the load is not smaller than the predetermined value, the command conversion section may convert the reference command into a return valve command indicating a degree of opening that is constant regardless of a change in the load; the intake valve command output unit may have a selection section that selects one command of the first valve command and the reference command related to the intake valve, and a command conversion section that converts the one command selected by the selection section of the intake valve command output unit into an intake valve command suitable for controlling the intake valve and outputs the intake valve command to the intake valve; when the first valve command and the reference command related to the intake valve are input, the selection section of the intake valve command output unit may select one of the commands indicating a larger degree of opening; and in a case where the one command selected by the selection section of the intake valve command output unit is the reference command, when the load is smaller than the predetermined value, the command conversion section of the intake valve command output unit may convert the reference command into an intake valve command indicating a degree of opening that is constant regardless of a change in the load, and when the load is not smaller than the predetermined value, the command conversion section may convert the reference command into an intake valve command indicating a degree of opening that changes with a positive correlation with a change in the load.

In this gas turbine cooling system, the degree of opening of the return vale decreases gradually as the load increases, when the load is smaller than the predetermined value and the return valve command output unit outputs a return valve command based on the reference command. When the degree of opening of the return valve decreases, the flow rate of the cooling air flowing through the return line decreases, so that the flow rate of the cooling air sent to the hot part increases. Thus, in this case, the return valve can be controlled so as to increase the flow rate of the cooling air sent to the hot part as the load increases.

Moreover, in this gas turbine cooling system, the degree of opening of the intake valve increases gradually as the load increases, when the load is not smaller than the predetermined value and the intake valve command output unit outputs an intake valve command based on the reference command. When the degree of opening of the intake valve increases, the flow rate of the cooling air sent to the hot part increases. Thus, in this case, the intake valve can be controlled so as to increase the flow rate of the cooling air sent to the hot part as the load increases.

In any one of the above gas turbine cooling systems including the intake valve, the intake valve command generation unit may stop generating the first valve command related to the intake valve when a condition under which the hot part is assumed to have returned to a sufficiently cooled state is met after a condition under which the likelihood of surging in the booster is assumed to have become low is met.

In this control system, the degree of opening of the intake valve is maintained at the load rejection-adapted degree of opening until the condition under which the hot part is assumed to have returned to a sufficiently cooled state is met.

A gas turbine facility as an aspect of the present invention to achieve the above object incudes any one of the above gas turbine cooling systems and the gas turbine.

A control method of a gas turbine cooling system as an aspect of the present invention to achieve the above object is a control method of a gas turbine cooling system including: a cooling air line that guides compressed air compressed by an air compressor of a gas turbine to a hot part coming in contact with combustion gas in the gas turbine; a cooler that cools the compressed air in the cooling air line to produce cooling air; a booster that pressurizes the cooling air in the cooling air line; a return line that returns the cooling air in a discharge line that is a line of the cooling air line located on the side of the hot part from the booster, to an intake air line that is a line of the cooling air line located on the side of the air compressor from the booster; and a return valve that is provided in the return line and adjusts the flow rate of the cooling air flowing through the return line.

The control method includes: a detection step of detecting a state amount of the cooling air flowing through the intake air line and a state amount of the cooling air flowing through the discharge line; a reception step of receiving a load rejection command indicating a load rejection of the gas turbine; a first valve command generation step of generating a first valve command indicating a degree of opening of the return valve according to the state amount detected in the detection step; a second valve command generation step of, when the load rejection command is received in the reception step, generating as a second valve command a valve command ordering the degree of opening of the return valve to be forcedly increased to a predetermined load rejection-adapted degree of opening, regardless of the state amount detected in the detection step; and a return valve command output step of outputting a return valve command based on the second valve command to the return valve when the second valve command is being generated in the second valve command generation step, and outputting a return valve command based on the first valve command to the return valve, according to a state of the gas turbine, when the second valve command is not being generated in the second valve command generation step.

As described above, in the event of a load rejection, the likelihood of surging in the booster increases rapidly. In this control method of a cooling system, when the load rejection command is received in the reception step, the second valve command is generated in the second valve command generation step. This second valve command is a valve command ordering the degree of opening of the return valve to be forcedly increased to the predetermined load rejection-adapted degree of opening, regardless of the state amount detected in the detection step. When the second valve command is generated in the second valve command generation step, a return valve command based on this second valve command is output to the return valve in the return valve command output step. As a result, the degree of opening of the return valve is forcedly increased to the load rejection-adapted degree of opening immediately after a load rejection.

When the degree of opening of the return valve increases, the flow rate of the cooling air flowing through the return line increases, so that the volume flow rate of the cooling air flowing through the booster increases. Thus, when the degree of opening of the return valve increases, the suction volume flow rate in the booster increases. Moreover, when the degree of opening of the return valve increases, the difference between the discharge pressure and the intake pressure of the booster decreases, so that the pressure ratio in the booster decreases. Therefore, when the degree of opening of the return valve increases, the likelihood of surging decreases.

Thus, this control method of a cooling system can reduce the likelihood of surging in the booster in the event of a load rejection. Accordingly, this control method of a cooling system can send cooling air to the hot part and cool this hot part even in the event of a load rejection.

In the above control method of a gas turbine cooling system, the load rejection-adapted degree of opening may be a degree of opening at which the return valve is fully open.

In any one of the above control methods of a gas turbine cooling system, in the second valve command generation step, when the load rejection command is received in the reception step, a valve command ordering the load rejection-adapted degree of opening to be maintained until a predetermined condition under which the likelihood of surging in the booster is assumed to have become low is met may be generated as the second valve command.

In the above control method of a gas turbine cooling system in which a valve command ordering the load rejection-adapted degree of opening to be maintained until the condition is met is generated as the second valve command, in the second valve command generation step, when the predetermined condition is met, a valve command ordering the degree of opening of the return valve to be reduced from the load rejection-adapted degree of opening may be generated as the second valve command.

In the above control method of a gas turbine cooling system in which, when the condition is met, a valve command ordering the degree of opening of the return valve to be reduced from the load rej ection-adapted degree of opening is generated as the second valve command, in the first valve command generation step, the first valve command indicating an increasing degree of opening of the return valve may be generated when the state amount detected in the detection step indicates that the likelihood of surging is increasing, and the first valve command indicating a decreasing degree of opening of the return valve may be generated when the state amount detected in the detection step indicates that the likelihood of surging is decreasing; and a rate of change in a closing direction of the degree of opening indicated by the second valve command when the predetermined condition is met may be higher than a maximum rate of change in the closing direction of the degree of opening indicated by the first valve command when the likelihood of surging is decreasing.

In the above control method of a gas turbine cooling system in which, when the condition is met, a valve command ordering the degree of opening of the return valve to be reduced from the load rejection-adapted degree of opening is generated as the second valve command, the rate of change in the degree of opening indicated by the second valve command when the predetermined condition is met may be a predetermined rate of change.

In the above control method of a gas turbine cooling system in which, when the condition is met, a valve command ordering the degree of opening of the return valve to be reduced from the load rejection-adapted degree of opening is generated as the second valve command, in the second valve command generation step, when the predetermined condition is met, a valve command indicating a degree of opening that is determined according to the state amount detected in the detection step may be generated as the second valve command.

In any one of the above control methods of a gas turbine cooling system in which, when the condition is met, a valve command ordering the degree of opening of the return valve to be reduced from the load rejection-adapted degree of opening is generated as the second valve command, in the second valve command generation step, generation of the second valve command may be stopped when a second condition is met after a first condition that is the predetermined condition is met.

In any one of the above control methods of a gas turbine cooling system, the gas turbine cooling system may include an intake valve that is provided in the intake air line and adjusts the flow rate of the cooling air flowing through the intake air line, and the control method may further include: an intake valve command generation step of, when the load rejection command is received in the reception step, generating a first valve command ordering the degree of opening of the intake valve to be forcedly increased to a predetermined load rejection-adapted degree of opening, regardless of the state amount detected in the detection step; and an intake valve command output step of outputting, to the intake valve, an intake valve command based on the first valve command generated in the intake valve command generation step.

In the above control method of a gas turbine cooling system including the intake valve command generation step, the load rejection-adapted degree of opening indicated by the first valve command generated in the intake valve command generation step may be a degree of opening at which the intake valve is fully open.

In any one of the above control methods of a gas turbine cooling system, the control method may further include a reference command generation step of generating a reference command indicating a degree of opening that changes with a positive correlation with a change in a load applied to the gas turbine; in the first valve command generation step, when the likelihood of surging in the booster has become high, a command indicating a degree of opening that is larger than the degree of opening indicated by the reference command may be generated as the first valve command related to the return valve, according to the state amount detected in the detection step; the return valve command output step may include a selection step of selecting one command of the first valve command, the second valve command, and the reference command related to the return valve, and a command conversion step of converting the one command selected in the selection step into a return valve command suitable for controlling the return valve and outputting the return valve command to the return valve; in the selection step, when the second valve command, and the first valve command or the reference command related to the return valve, are input, the second valve command may be selected, and when the second valve command is not input and the first valve command and the reference command are input, one of the commands indicating a larger degree of opening may be selected; and in the command conversion step, in a case where the one command selected in the selection step is the reference command, when the load is smaller than a predetermined value, the reference command may be converted into a return valve command indicating a degree of opening of the return valve that changes with a negative correlation with a change in the load, and when the load is not smaller than the predetermined value, the reference command may be converted into a return valve command indicating a degree of opening that is constant regardless of a change in the load.

In any one of the above control methods of a gas turbine cooling system including the intake valve, the control method may further include a reference command generation step of generating a reference command indicating a degree of opening that changes with a positive correlation with a change in a load applied to the gas turbine; in the first valve command generation step, when the likelihood of surging in the booster has become high, a command indicating a degree of opening that is larger than the degree of opening indicated by the reference command may be generated as the first valve command related to the return valve, according to the state amount detected in the detection step; the return valve command output step may include a selection step of selecting one command of the first valve command, the second valve command, and the reference command related to the return valve, and a command conversion step of converting the one command selected in the selection step into a return valve command suitable for controlling the return valve and outputting the return valve command to the return valve; in the selection step, when the second valve command, and the first valve command or the reference command related to the return valve, are input, the second valve command may be selected, and when the second valve command is not input and the first valve command and the reference command are input, one of the commands indicating a larger degree of opening may be selected; in the command conversion step, in a case where the one command selected in the selection step is the reference command, when the load is smaller than a predetermined value, the reference command may be converted into a return valve command indicating a degree of opening of the return valve that changes with a negative correlation with a change in the load, and when the load is not smaller than the predetermined value, the reference command may be converted into a return valve command indicating a degree of opening that is constant regardless of a change in the load; the intake valve command output step may include a selection step of selecting one command of the first valve command and the reference command related to the intake valve, and a command conversion step of converting the one command selected in the selection step of the intake valve command output step into an intake valve command suitable for controlling the intake valve and outputting the intake valve command to the intake valve; in the selection step of the intake valve command output step, when the first valve command and the reference command related to the intake valve are input, one of the commands indicating a larger degree of opening may be selected; and in the command conversion step of the intake valve command output step, in a case where the one command selected in the selection step of the intake valve command output step is the reference command, when the load is smaller than the predetermined value, the reference command may be converted into an intake valve command indicating a degree of opening that is constant regardless of a change in the load, and when the load is not smaller than the predetermined value, the reference command may be converted into an intake valve command indicating a degree of opening that changes with a positive correlation with a change in the load.

In any one of the above control methods of a gas turbine cooling system including the intake valve, in the intake valve command generation step, generation of the first valve command related to the intake valve may be stopped when a condition under which the hot part is assumed to have returned to a sufficiently cooled state is met after a condition under which the likelihood of surging in the booster is assumed to have become low is met.

### Advantageous Effects of Invention

One aspect of the present invention makes it possible to reduce the likelihood of surging in a booster in the event of a load rejection. Thus, this aspect of the present invention makes it possible to send cooling air to a hot part and cool this hot part even in the event of a load rejection.

### BRIEF DESCRIPTION OF DRAWINGS

FIG. 1 is a system diagram of a gas turbine facility in an embodiment according to the present invention.

FIG. 2 is a view illustrating the concept of split control in the embodiment according to the present invention.

FIG. 3 is a graph showing characteristics of a booster in the embodiment according to the present invention.

FIG. 4 is a functional block diagram of a control device in the embodiment according to the present invention.

FIG. 5 is a flowchart showing operations of the control device in the embodiment according to the present invention.

FIG. 6 is a timing chart showing operations etc. of parts of the gas turbine facility in the embodiment according to the present invention, in which FIG. 6(a) is a chart showing changes in a load indicated by a load rejection command; FIG. 6(b) is a chart showing changes in the degree of opening of an intake valve, and FIG. 6(c) is a chart showing changes in the degree of opening of a return valve.

FIG. 7 is a functional block diagram of a control device in a modified example of the embodiment according to the present invention.

### DESCRIPTION OF EMBODIMENTS

### Embodiment

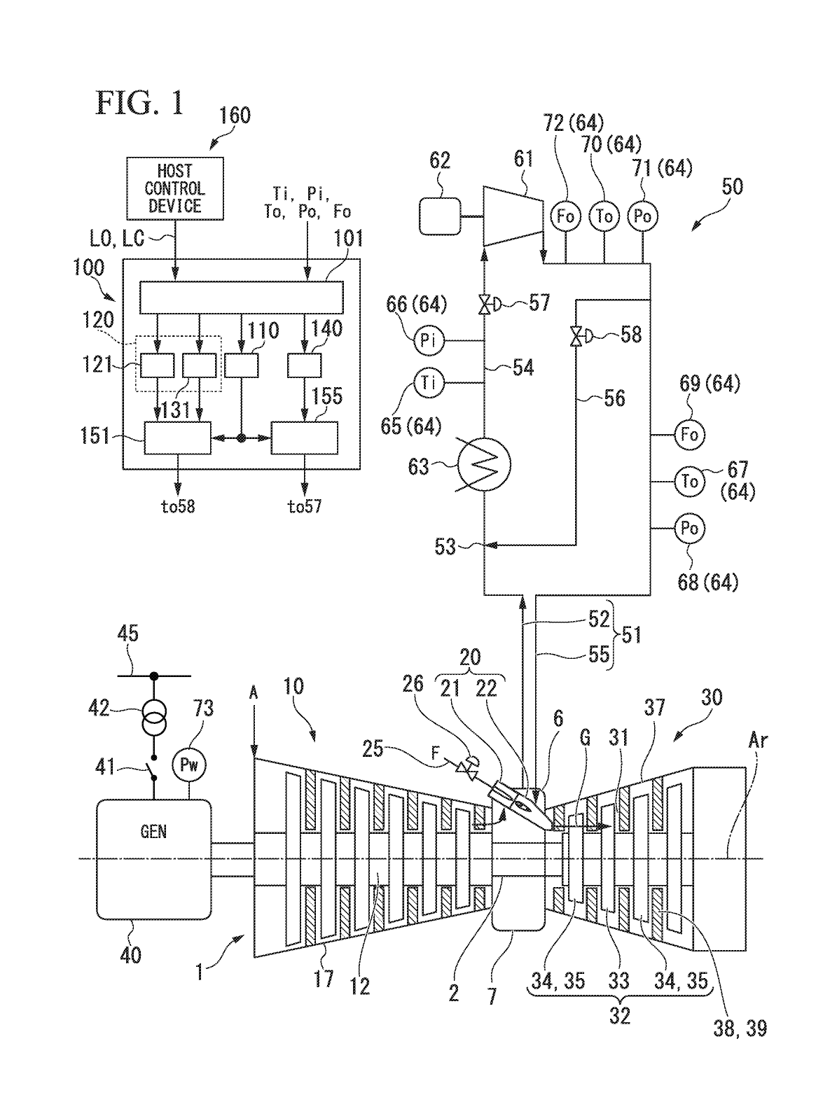

In the following, an embodiment of a gas turbine facility according to the present invention will be described in detail with reference to FIG. 1 to FIG. 6.

As shown in FIG. 1, the gas turbine facility of this embodiment includes a gas turbine 1, and a gas turbine cooling system (hereinafter referred to simply as the cooling system) 50 that cools hot parts of the gas turbine 1.

The gas turbine 1 includes an air compressor 10 that generates compressed air by compressing outside air A, a combustor 20 that generates combustion gas G by combusting fuel F from a fuel supply source in the compressed air, and a turbine 30 that is driven by the combustion gas G.

The air compressor 10 has a compressor rotor 12 that rotates around an axis Ar, and a compressor casing 17 that covers the compressor rotor 12. The turbine 30 has a turbine rotor 32 that rotates around the axis Ar, and a turbine casing 37 that covers the turbine rotor 32. The compressor rotor 12 and the turbine rotor 32 are located on the same axis Ar, and are coupled together to form a gas turbine rotor 2. The gas turbine 1 further includes an intermediate casing 6 that is disposed between the compressor casing 17 and the turbine casing 37. The combustor 20 is mounted on the intermediate casing 6. The compressor casing 17, the intermediate casing 6, and the turbine casing 37 are coupled together to form a gas turbine casing 7. Hereinafter, the direction in which the axis Ar extends will be referred to as an axial direction. In the axial direction, the side on which the air compressor 10 is present relative to the turbine 30 will be referred to as an axially upstream side, and the opposite side from the axially upstream side will be referred to as an axially downstream side.

The turbine rotor 32 has a rotor shaft 33, and a plurality of blade rows 34 that are provided on the rotor shaft 33. The plurality of blade rows 34 are arrayed in the axial direction. Each blade row 34 has a plurality of blades 35 that are arrayed in a circumferential direction based on the axis Ar. The turbine 30 further has a plurality of vane rows 38 that are fixed on an inner circumferential side of the turbine casing 37. The vane rows 38 are each disposed on the axially upstream side of one blade row 34. Each vane row 38 has a plurality of vanes 39 that are arrayed in the circumferential direction based on the axis Ar. An annular space between the inner circumferential side of the turbine casing 37 and an outer circumferential side of the rotor shaft 33 forms a combustion gas flow passage 31 through which the combustion gas G flows.

The combustor 20 has a combustion liner 22 through which the combustion gas G is sent to the combustion gas flow passage 31 of the turbine 30, and a fuel injector 21 that injects the fuel F and the compressed air into the combustion liner 22. A fuel line 25 through which the fuel F is sent to the fuel injector 21 is connected to the fuel injector 21. A fuel valve 26 that adjusts the flow rate of the fuel F flowing through the fuel line 25 is provided in the fuel line 25.

Of various parts composing the gas turbine 1, the combustion liner 22 of the combustor 20, the blades 35, and the vanes 39 each constitute a hot part that is exposed to the combustion gas G.

A generator 40 is connected to the gas turbine rotor 2. The generator 40 is electrically connected to an electric power system 45 through a breaker 41 and a transformer 42.

The cooling system 50 includes a cooling air line 51, a return line 56, a booster 61, a cooler 63, an intake valve 57, a return valve 58, a detector 64, and a control device 100 that controls operations of the return valve 58 and the intake valve 57.

The cooling air line 51 is connected to the intermediate casing 6 and connected to the combustion liner 22 that is one of the hot parts. The cooling air line 51 guides, to the combustion liner 22, the compressed air having flowed from the air compressor 10 into the intermediate casing 6. The cooler 63 cools the compressed air in the cooling air line 51 to produce cooling air. For example, the cooler 63 is a heat exchanger that causes the compressed air in the cooling air line 51 and a coolant to exchange heat with each other and thereby cools the compressed air. While the cooler 63 here is a heat exchanger, the cooler 63 may instead be a cooler, for example, having a radiator through the inside of which compressed air passes, and a fan that sends air to this radiator. The booster 61 pressurizes the cooling air in the cooling air line 51. For example, the booster 61 is a centrifugal compressor or an axial compressor. The booster 61 is driven by a motor 62. Hereinafter, of the cooling air line 51, a part from the intermediate casing 6 to the booster 61 will be referred to as an intake air line 52, and a part from the booster 61 to the combustion liner 22 will be referred to as a discharge line 55. Of the intake air line 52, a part from the intermediate casing 6 to the cooler 63 will be referred to as an uncooled intake air line 53, and a part from the cooler 63 to the booster 61 will be referred to as a cooled intake air line 54. The return line 56 connects the discharge line 55 and the uncooled intake air line 53 to each other. The return line 56 is a line that returns the cooling air in the discharge line 55 to the uncooled intake air line 53. The return valve 58 is provided in the return line 56. The degree of opening of the return valve 58 is controlled so as to be able to adjust the flow rate of the cooling air flowing through the discharge line 55. The intake valve 57 is provided in the cooled intake air line 54. The intake valve 57 adjusts the flow rate of the cooling air flowing through the cooled intake air line 54, i.e., the cooling air suctioned by the booster 61.

The detector 64 includes an intake temperature indicator 65 that detects a temperature Ti of the cooling air flowing through the cooled intake air line 54, an intake pressure indicator 66 that detects a pressure Pi of the cooling air flowing through the cooled intake air line 54, discharge temperature indicators 67, 70 that detect a temperature To of the cooling air flowing through the discharge line 55, discharge pressure indicators 68, 71 that detect a pressure Po of the cooling air flowing through the discharge line 55, and discharge flowmeters 69, 72 that detect a volume flow rate Fo of the cooling air flowing through the discharge line 55. All of the discharge temperature indicator 67, the discharge pressure indicator 68, and the discharge flowmeter 69 are provided in the discharge line 55, farther on the side of the combustion liner 22 than a position at which the return line 56 is connected. All of the discharge temperature indicator 70, the discharge pressure indicator 71, and the discharge flowmeter 72 are provided in the discharge line 55, farther on the side of the booster 61 than the position at which the return line 56 is connected.

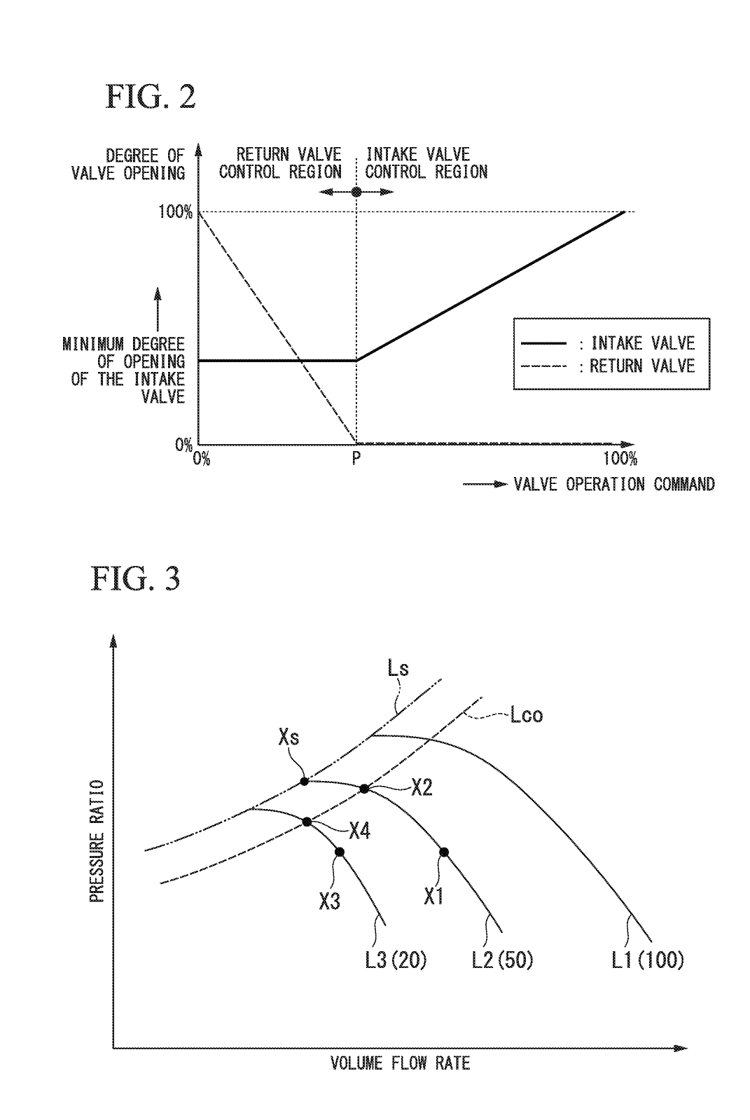

A method of controlling the flow rate of the cooling air supplied from the cooling system 50 to the combustion liner 22 will be described below using FIG. 2.

As described above, the compressed air extracted from the intermediate casing 6 is cooled by the cooler 63 provided in the intake air line 52, and is suctioned by the booster 61 via the intake valve 57. Part of the cooling air pressurized by the booster 61 is returned from the return line 56 having the return valve 58 to the uncooled intake air line 53, while the rest of the cooling air is supplied to the combustion liner 22 through the discharge line 55. The return line 56 is a line that is provided to prevent the booster 61 from entering a surge region, and thus to protect the booster 61. The flow rate of the cooling air flowing through the discharge line 55 during normal operation of the booster 61 is adjusted by controlling the intake valve 57 and the return valve 58. However, if the intake valve 57 and the return valve 58 are controlled independently of each other, the control becomes unstable due to mutual interference. A common method used to avoid such mutual interference of control valves is to control the flow rate of cooling air by dividing a valve operation command for the control valves into a high-load flow rate region and a low-load flow rate region of the cooling air (this method will be referred to as split control).

FIG. 2 shows the concept of the split control of the cooling air flowing through the discharge line 55 based on a combination of the intake valve 57 and the return valve 58.

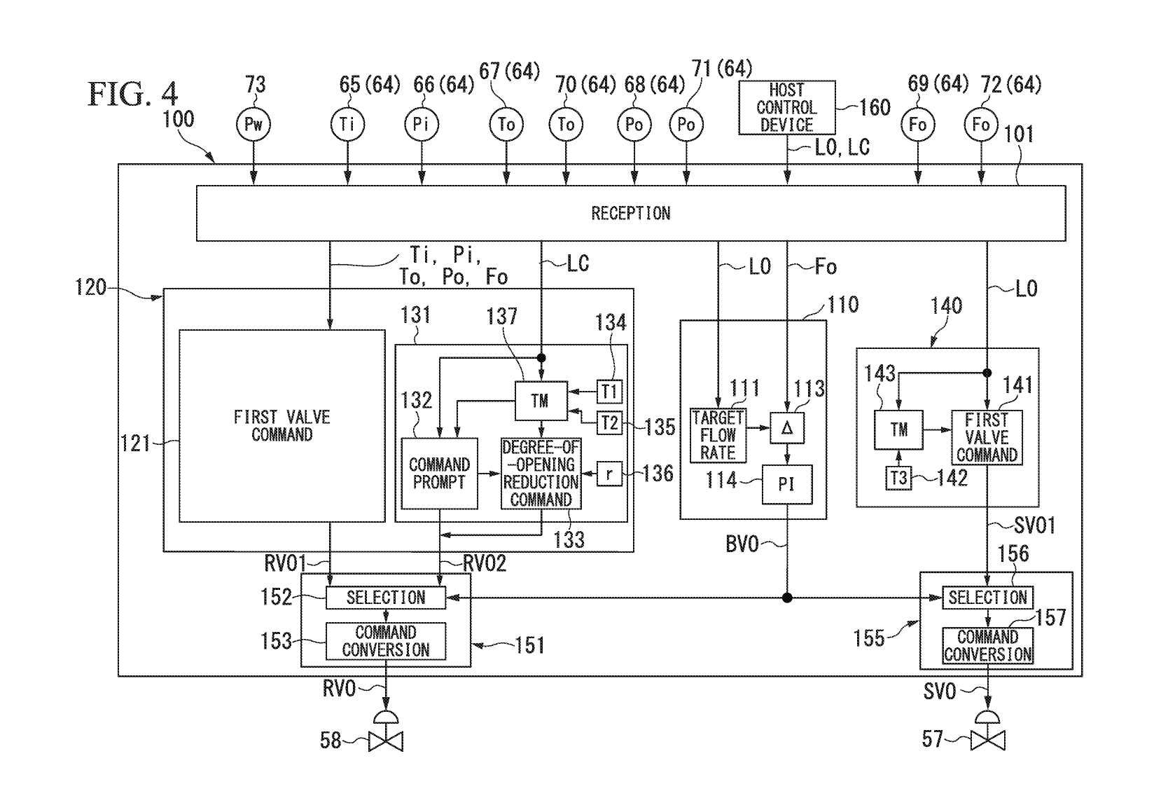

The vertical axis shows the degree of valve opening (%) of the intake valve 57 or the return valve 58. The horizontal axis shows a valve operation command (%) that is output to the intake valve 57 or the return valve 58 during normal operation. The valve operation command here refers to a valve command such as BVO to be described later using FIG. 4. However, this valve operation command does not include RVO2. The solid line shows the intake valve 57, and the dashed line shows the return valve 58. As shown in FIG. 2, a split point P at which the high-load flow rate region and the low-load flow rate region of the cooling air are divided as described above is typically a point at which the valve operation command is 50%. The region where the valve operation command is smaller than 50% relative to the split point P is the low-load flow rate region, and the region where the valve operation command is not smaller than 50% relative to the split point P is the high-load flow rate region. However, the valve operation command of 50% indicating the position of the split point P is merely an example, and the split point P is not limited to this value.

When the cooling air is in the high-load flow rate region, the amount of cooling air flowing through the discharge line 55 is adjusted through a degree of valve opening based on the valve operation command for the intake valve 57 (intake valve control region). In this region, the return valve 58 is fully closed. Specifically, in the high-load flow rate region where the amount of cooling air is larger than that at the split point P, the required amount of cooling air increases as the load on the gas turbine 1 increases. Therefore, as the valve operation command increases, the degree of valve opening of the intake valve 57 increases and the amount of cooling air increases. When the load on the gas turbine 1 decreases, the valve operation command decreases and the degree of valve opening of the intake valve 57 decreases accordingly, reaching a minimum degree of opening at the split point P. The minimum degree of opening of the intake valve 57 is typically 20%, at which the degree of opening remains constant. However, the minimum degree of opening of 20% is merely an example, and the minimum degree of opening is not limited to this value.

On the other hand, when the cooling air is in the low-load flow rate region relative to the split point P, the intake valve 57 is maintained at the minimum degree of opening. To further reduce the amount of cooling air flowing through the discharge line 55 as the load on the gas turbine 1 decreases, the valve operation command need be further reduced from that at the split point P. However, when the amount of cooling air flowing through the booster 61 decreases, the booster 61 may enter the surge region. Therefore, to protect the booster 61 from a surge phenomenon, the return valve 58 starts to open. This region is a region of anti-surge control aimed at protecting the booster 61. Specifically, the degree of valve opening of the return valve 58 is controlled so as to secure a certain flow rate of the cooling air flowing through the booster 61 for anti-surge purposes, while adjusting the amount of cooling air flowing through the discharge line 55 to a lower flow rate. As a result, it is possible to control the amount of cooling air flowing through the discharge line 55, and at the same time to secure a certain flow rate of the cooling air flowing through the booster 61, so that a surge phenomenon in the booster 61 is avoided. As described above, in this low-load flow rate region, the intake valve 57 is maintained at a constant degree of opening that is the minimum degree of opening, and the amount of cooling air flowing through the discharge line 55 is adjusted through the degree of valve opening of the return valve 58.

Next, a relation between the volume flow rate and the pressure ratio in the booster will be described using FIG. 3.

In the booster 61 that raises the pressure of the cooling air, there is a certain relation among the volume flow rate of the cooling air suctioned by the booster 61, the pressure ratio (=discharge pressure/intake valve inlet pressure) in the booster 61, and the degree of opening of the intake valve.

Therefore, as means for expressing the characteristics of the booster 61, a graph as shown in FIG. 3 that has the volume flow rate on the horizontal axis and the pressure ratio on the vertical axis, with the degree of opening of the intake valve serving as a parameter, can express the characteristics of the booster 61. The booster 61 commonly has such characteristics that the pressure ratio decreases as the volume flow rate increases. In FIG. 3, three characteristic lines L1, L2, L3 at different degrees of opening of the intake valve 57 as a parameter are shown as examples. Specifically, these lines are the characteristic line L1 (100) at the degree of opening of the intake valve of 100%, the characteristic line L2 (50) at the degree of opening of the intake valve of 50%, and the characteristic line L3 (20) at the degree of opening of the intake valve of 20%. When the pressure ratio in the booster 61 and the degree of opening of the intake valve 57 are specified, the volume flow rate of the cooling air flowing through the booster 61 can be determined.

When the degree of opening of the intake valve is constant, the booster 61 is operated at a point on the characteristic line corresponding to that degree of opening. This will be described by taking the characteristic line L2 (50) as an example. When the degree of opening of the intake valve 57 is maintained at 50%, an operation point X1 on the characteristic line L2 (50) moves on the characteristics line L2 (50) along this characteristic line. A point on the characteristic line L2 (50) at which the pressure ratio is highest and the volume flow rate is lowest, i.e., a point Xs at the end of the characteristic line on the higher side of the pressure ratio, is an operation point at which the volume flow rate is lowest and surging can occur in the booster 61. Thus, a line connecting points Xs on a plurality of characteristic lines at different degrees of opening of the intake valve 57 is called a surge line Ls. A line having a margin for the volume flow rate relative to the surging point Xs on the surge line Ls is called a control line Lco.

During normal operation, the booster 61 is operated based on a target flow rate of the cooling air derived from a load command. At the normal operation point X1, the booster 61 is operated according to the characteristic line corresponding to the degree of opening of the intake valve 57 and within a region where the volume flow rate is higher than that on the control line Lco. When the required flow rate of the cooling air has decreased due to a change in the operation conditions of the combustor 20 and the operation point X1 has reached a point X2 on the control line Lco, the booster 61 enters on an anti-surge control operation to protect itself from surging. The anti-surge control is a method for protecting the booster 61 from surging by controlling the flow rate of the cooling air flowing through the booster 61 so as not to decrease beyond the control line Lco. Specifically, when the operation point X1 has reached the control line Lco, an operation condition different from an operation condition for normal operation is given to the control device, and the return valve 58 starts to open. As the return valve 58 opens, a certain flow rate of the cooling air flowing through the booster 61 is secured without a decrease in the flow rate. Thus, at the operation point X1 of the booster 61, the volume flow rate further decreases beyond the control line Lco. In this way, the degree of opening of the return valve 58 is controlled so that the operation point X1 of the booster 61 remains on the control line Lco without entering the surge region, i.e., the region between the surge line Ls and the control line Lco where the likelihood of surging is high.

When the operation point X1 has reached the surge line Ls due to some change in the operation conditions of the booster 61, the return valve 58 is forcedly opened, so that the flow rate of the cooling air flowing through the booster 61 increases and surging in the booster 61 is avoided.

When the pressure ratio decreases and the booster 61 having been operating in the anti-surge control region on the control line Lco enters a normal operation region, the flow rate of the cooling air flowing through the discharge line 55 is adjusted based on the target flow rate for normal operation.

As shown in FIG. 4, the control device 100 has a reception unit 101, a reference command generation unit 110, a return valve command generation unit 120, an intake valve command generation unit 140, a return valve command output unit 151, and an intake valve command output unit 155.

The reception unit 101 receives a state amount of the cooling air detected by the detector 64, and receives a load command LO and a load rejection command LC from a host control device 160. Here, the load command LO is a command indicating a load applied to the gas turbine 1, in other words, the output of the gas turbine 1. A load rejection refers to interrupting electrical connection between the generator 40 that is connected to the gas turbine rotor 2 and the electric power system 45. Therefore, the load rejection command LC is a command ordering electrical connection between the generator 40 and the electric power system 45 to be interrupted.

The configuration of the control device during the above-described normal operation will be described below.

The reference command generation unit 110 has a target flow rate generation section 111, a flow rate deviation computation section 113, and a PI controller 114. The target flow rate generation section 111 obtains a target flow rate for the booster 61 according to the load indicated by the load command LO. This target flow rate is a value that changes with a positive correlation with a change in the load indicated by the load command LO. Thus, when the load indicated by the load command LO increases, the target flow rate also increases. Alternatively, an intake air flowmeter that detects the volume flow rate of the cooling air flowing through the cooled intake air line 54 may be provided, and the target flow rate may also be obtained from this intake air flowmeter. The flow rate deviation computation section 113 obtains a flow rate deviation Δ of a discharge volume flow rate detected by the discharge flowmeter 72 from the target flow rate obtained by the target flow rate generation section 111. The PI controller 114 obtains an amount of proportional-plus-integral action according to the flow rate deviation A, and generates a valve operation command BVO indicating a degree of opening of the intake valve 57 or the return valve 58 according to this amount of proportional-plus-integral action. However, any other parameter that changes with a positive correlation with a change in the load may also be used to determine the target flow rate for the booster 61. For example, the target flow rate may be determined according to an output detected by an output meter 73 of the generator 40. Instead of the target flow rate, a target pressure obtained by converting the target flow rate into a pressure may be used, and a pressure deviation between the target pressure and a detected discharge pressure may be obtained. In this case, the PI controller 114 may obtain an amount of proportional-plus-integral action according to this pressure deviation, and may generate the valve operation command BVO according to this amount of proportional-plus-integral action.

The return valve command generation unit 120 has a first valve command generation section 121 and a second valve command generation section 131. The first valve command generation section 121 generates a first valve command RVO1 indicating a degree of opening of the return valve 58 in the above-described anti-surge control region of the booster 61. When the load rejection command LC is received, the second valve command generation section 131 generates a second valve command RVO2 that is a valve command ordering the degree of opening of the return valve 58 to be forcedly increased to a predetermined load rejection-adapted degree of opening.

The first valve command generation section 121 is responsible for the anti-surge control of the booster 61, and functions as a booster protection command generation section for protecting the booster 61 from surging. Specifically, when the operation point X1 of the booster 61 has reached the control line Lco, a target flow rate different from an operation condition for normal operation is given to the control device. The first valve command generation section 121 obtains a deviation A between the target flow rate and a suction flow rate that is calculated from the volume flow rate Fo detected by the discharge flowmeter 72, and obtains an amount of proportional-plus-integral action according to the flow rate deviation A, and outputs the first valve command RVO1 indicating the degree of opening according to this amount of proportional-plus-integral action.

The second valve command generation section 131 has a command prompt generation part 132, a degree-of-opening reduction command generation part 133, a first condition storage part 134, a second condition storage part 135, a rate-of-change storage part 136, and a timer 137. The command prompt generation part 132 outputs a valve command indicating the predetermined load rejection-adapted degree of opening as the second valve command RVO2 immediately after receiving the load rejection command LC. The rate-of-change storage part 136 stores a rate of change r that is an amount of decrease per unit time in the degree of opening of the return valve 58. The degree-of-opening reduction command generation part 133 outputs, as the second valve command RVO2, a valve command indicating a degree of opening of the return valve 58 that changes at the rate of change r stored in the rate-of-change storage part 136. The first condition storage part 134 stores a first time T1 that is a time after which the likelihood of surging in the booster 61 is assumed to have become low since the reception of the load rejection command LC. The second condition storage part 135 stores a second time T2 that is a time longer than the first time T1. The timer 137 counts a time from the reception of the load rejection command LC until the first time T1 elapses, and also counts a time from the reception of the load rejection command LC until the second time T2 elapses. The command prompt generation part 132 generates the second valve command RVO2 until the timer 137 recognizes a lapse of the first time T1 after the reception of the load rejection command LC. The degree-of-opening reduction command generation part 133 outputs the second valve command RVO2 until the timer 137 recognizes a lapse of the second time T2 after recognizing a lapse of the first time T1.

The intake valve command generation unit 140 has a first valve command generation section 141, a third condition storage section 142, and a timer 143. The first valve command generation section 141 outputs a valve command indicating the predetermined load rejection-adapted degree of opening as a first valve command SVO1 immediately after the load rejection command LC is received. The third condition storage section 142 stores a third time T3 (>T1, T2) that is a time after which the combustion liner 22 is assumed to have returned to a sufficiently cooled state since the reception of the load rejection command LC. The timer 143 counts a time from the reception of the load rejection command LC until the third time T3 elapses. The first valve command generation section 141 generates the first valve command SVO1 until the timer 143 recognizes a lapse of the third time T3 after the reception of the load rejection command LC.

The return valve command output unit 151 has a selection section 152 and a command conversion section 153. The selection section 152 selects one command of the first valve command RVO1 and the second valve command RVO2 from the return valve command generation unit 120 and the reference command BVO from the reference command generation unit 110. When the first valve command RVO1 or the reference command BVO is input other than the second valve command RVO2, the selection section 152 selects the second valve command RVO2. When the first valve command RVO1 and the reference command BVO are input, the selection section 152 selects one of the commands indicating a larger degree of opening as the degree of opening. The command conversion section 153 converts the one command selected by the selection section 152 into a return valve command RVO suitable for controlling the return valve 58, and outputs this return valve command RVO to the return valve 58. In a case where the one command selected by the selection section 152 is the reference command BVO, when the command value of the valve command is smaller than a predetermined value, the command conversion section 153 converts the reference command BVO into the return valve command RVO indicating a degree of opening of the return valve 58 that changes with a negative correlation with a change in the load. When the command value of the valve command is not smaller than the predetermined value, the command conversion section 153 converts the reference command BVO into the return valve command RVO indicating a degree of opening that is constant regardless of a change in the valve command.

The intake valve command output unit 155 also has a selection section 156 and a command conversion section 157. The selection section 156 selects one command of the first valve command SVO1 from the intake valve command generation unit 140 and the reference command BVO from the reference command generation unit 110. When the first valve command SVO1 and the reference command BVO are input, the selection section 156 selects the first valve command SVO1. In other words, when the first valve command SVO1 and the reference command BVO are input, the selection section 156 selects one of the commands indicating a larger degree of opening as the degree of opening. The command conversion section 157 converts the one command selected by the selection section 156 into an intake valve command SVO suitable for controlling the intake valve 57, and outputs this intake valve command SVO to the intake valve 57. In a case where the one command selected by the selection section 156 is the reference command BVO, when the command value of the valve command is smaller than a predetermined value, the command conversion section 157 converts the reference valve command into the intake valve command SVO indicating a degree of opening that is constant regardless of a change in the valve command. When the command value of the valve command is not smaller than the predetermined value, the command conversion section 157 converts the reference command BVO into the intake valve command SVO indicating a degree of opening of the intake valve 57 that changes with a positive correlation with a change in the valve command.

Now, the form of conversion of the reference command BVO in the command conversion section 153 of the return valve command output unit 151 and the command conversion section 157 of the intake valve command output unit 155 will be specifically described using FIG. 4. Here, the above-mentioned predetermined value related to the valve command is 50%. The above-mentioned predetermined value related to the valve command is a value that is determined according to the valve characteristics of the return valve 58 etc., and is therefore not limited to this value.

When the command value of the valve command is smaller than the predetermined 50%, the command conversion section 153 of the return valve command output unit 151 converts the reference command BVO into the return valve command RVO indicating a degree of opening that changes with a negative correlation with a change in the degree of opening indicated by the reference command BVO and in the valve command. In other words, the command conversion section 153 converts the reference command BVO into the return valve command RVO indicating a degree of opening of the return valve 58 that decreases as the degree of opening indicated by the reference command BVO and the command value of the valve command increase. When the command value of the valve command is 0%, the degree of opening indicated by the return valve command RVO is 100%, for example. When the command value of the valve command is not smaller than 50%, the degree of opening indicated by the return valve command RVO is constant at 0%, for example.

When the command value of the valve command is not smaller than the predetermined 50%, the command conversion section 157 of the intake valve command output unit 155 converts the reference command BVO into the intake valve command SVO indicating a degree of opening that changes with a positive correlation with a change in the degree of opening indicated by the reference command BVO and in the valve command. In other words, in this case, the command conversion section 157 converts the reference command BVO into the intake valve command SVO indicating a degree of opening of the intake valve 57 that increases as the degree of opening indicated by the reference command BVO and the command value of the valve command increase. When the command value of the valve command is 50%, the degree of opening indicated by the intake valve command SVO is 20%, for example. When the command value of the valve command is smaller than 50%, the degree of opening indicated by the intake valve command SVO is constant at 20%, for example.

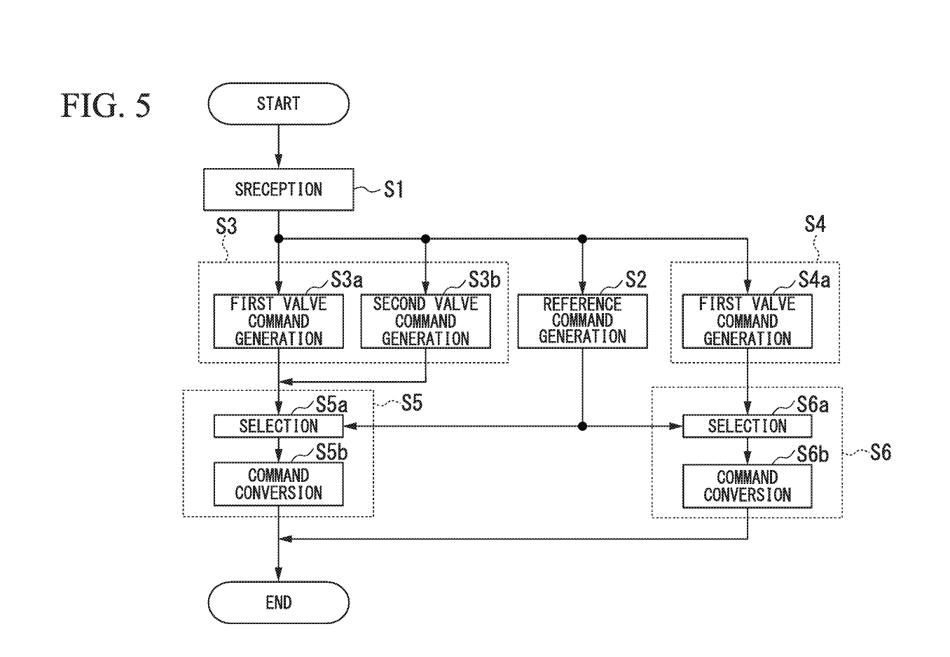

Next, the operations of the control device 100 will be described in accordance with the flowchart shown in FIG. 5.

The detector 64 constantly detects the state amount of cooling air, and sends this state amount to the control device 100 (detection step).

The reception unit 101 of the control device 100 receives the load command LO and the load rejection command LC from the host control device 160, and receives at any time the state amount of the cooling air detected by the detector 64 (Si: reception step).

The reference command generation unit 110 of the control device 100 generates the reference command BVO according to the load command etc. received by the reception unit 101 (S2: reference command generation step). The return valve command generation unit 120 of the control device 100 generates a valve command for the return valve 58 according to the state amount etc. received by the reception unit 101 (S3: return valve command generation step). In parallel with this return valve command generation step (S3), the intake valve command generation unit 140 of the control device 100 generates a valve command for the intake valve 57 according to the state amount etc. received by the reception unit 101 (S4: intake valve command generation step).

In the reference command generation step (S2), the target flow rate generation section 111 of the reference command generation unit 110 generates a target flow rate for the booster 61 according to the load indicated by the load command LO. As described above, this target flow rate is a value that changes with a positive correlation with a change in the load indicated by the load command LO. The flow rate deviation computation section 113 of the reference command generation unit 110 obtains the deviation A between the target flow rate and the discharge flow rate Fo detected by the discharge flowmeter 69. The PI controller 114 of the reference command generation unit 110 obtains an amount of proportional-plus-integral action according to the flow rate deviation A, and generates the reference command BVO for the return valve 58 and the intake valve 57 according to this amount of proportional-plus-integral action.

The return valve command generation step (S3) covers the anti-surge control of the booster 61 described above. Specifically, as shown in FIG. 3, when the operation point X1 of the booster 61 has reached the control line Lco, a target flow rate different from the operation condition for normal operation is given to the control device. The first valve command generation section 121 of the return valve command generation unit 120 obtains a deviation A between the target flow rate and the volume flow rate Fo detected by the discharge flowmeter 72. Then, the first valve command generation section 121 obtains an amount of proportional-plus-integral action according to this flow rate deviation A, and outputs a valve command indicating a degree of opening of the return valve 58 according to this amount of proportional-plus-integral action as the first valve degree-of-opening command ROV1.

In the return valve command generation step (S3), when the reception unit 101 receives the load rejection command LC, the second valve command generation section 131 for the return valve 58 generates the second valve command RVO2 for the return valve 58 (S3b: second valve command generation step). This second valve command generation step (S3b) will be described in detail later.

In the intake valve command generation step (S4), when the reception unit 101 receives the load rejection command LC, the first valve command generation section 141 for the intake valve 57 generates the first valve command SVO1 indicating the load rejection-adapted degree of opening that is stored in advance (S4a: first valve command generation step). This load rejection-adapted degree of opening is, for example, a degree of opening at which the intake valve 57 is fully open. However, the load rejection-adapted degree of opening may be any degree of opening that is larger than the degree of opening indicated by the intake valve command SVO based on the reference command BVO at a point in time when the first valve command SVO1 is generated, and for example, the load rejection-adapted degree of opening may be a degree of opening of 90%.

The return valve command output unit 151 outputs the return valve command RVO to the return valve 58 (S5: return valve command output step). The intake valve command output unit 155 outputs the intake valve command SVO to the intake valve 57 (S6: intake valve command output step).

In the return valve command output step (S5), the selection section 152 of the return valve command output unit 151 selects one command of the first valve command RVO1, the second valve command RVO2, and the reference command BVO related to the return valve 58 (S5a: selection step). When one or more commands are received, the selection section 152 basically selects a command of the plurality of commands that indicates the largest degree of opening as the degree of opening of the return valve 58. In the return valve command output step (S5), moreover, the command conversion section 153 of the return valve command output unit 151 converts the one command selected in the selection step (S5a) into the return valve command RVO suitable for controlling the return valve 58, and outputs this return valve command RVO to the return valve 58 (S5b: command conversion step).

In an intake valve command output step (S6), the selection section 156 of the intake valve command output unit 155 selects one command of the first valve command SVO1 and the reference command BVO related to the intake valve 57 (S6a: selection step). When one or more commands are received, the selection section 156 selects a command of the plurality of commands that indicates a larger degree of opening as the degree of opening of the intake valve 57. In the intake valve command output step (S6), moreover, the command conversion section 157 of the intake valve command output unit 155 converts the one command selected in the selection step (S6a) into the intake valve command SVO suitable for controlling the intake valve 57, and outputs this intake valve command SVO to the intake valve 57 (S6b: command conversion step).

For example, as shown in FIG. 3, when the operation points X1, X3 of the booster 61 are located on the side where the pressure ratio is lower and the volume flow rate is higher than those on the control line Lco, and the return valve command generation unit 120 is not generating the second valve command RVO2, the reference command BVO is selected from the first valve command RVO1 and the reference command BVO related to the return valve 58 in the selection step (S5a) of the return valve command output step (S5). When the operation points X1, X3 of the booster 61 are located on the side where the pressure ratio is lower and the volume flow rate is higher than those on the control line Lco, and the intake valve command generation unit 140 is not generating the first valve command SVO1, the reference command BVO is selected in the selection step (S6a) of the intake valve command output step (S6).

When the return valve command RVO based on the reference command BVO is output to the return valve 58, the degree of opening of the return valve 58 is set to the degree of opening indicated by this return valve command RVO. As described above using FIG. 2, the degree of opening indicated by the return valve command RVO based on the reference command BVO is, for example, 100% when the command value of the valve command is 0%, and decreases gradually as the command value of the valve command approaches 50%, and is, for example, 0% when the command value of the valve command is 50%. When the degree of opening of the return valve 58 decreases as the command value of the valve command increases, the amount of cooling air flowing through the return line 56 decreases, and conversely the amount of cooling air flowing through the discharge line 55 increases. Thus, when the command value of the valve command is smaller than 50%, the degree of opening of the return valve 58 decreases as the command value increases, so that the flow rate of the cooling air supplied to the combustion liner 22 increases. On the other hand, once the command value of the valve command reaches or exceeds 50%, the degree of opening of the return valve 58 is maintained at 0%, for example, even when the command value increases.

When the intake valve command SVO based on the reference command BVO is output to the intake valve 57, the degree of opening of the intake valve 57 is set to the degree of opening indicated by the intake valve command SVO. As described above using FIG. 2, when the command value of the valve command is smaller than 50%, the degree of opening indicated by the intake valve command SVO based on the reference command BVO is constant at 20%, for example. When the command value of the valve command is not smaller than 50%, the degree of opening of the intake valve command SVO based on the reference command BVO increases gradually as the command value increases. When the degree of opening of the intake valve 57 increases, the amount of cooling air flowing through the discharge line 55 increases. Thus, when the command value of the valve command is not smaller than 50%, the degree of opening of the intake valve 57 increases as the load increases, so that the flow rate of the cooling air supplied to the combustion liner 22 increases.

As has been described above, in this embodiment, when the operation point of the booster 61 is located on the side where the pressure ratio is lower and the volume flow rate is higher than those on the control line Lco, and the command value of the valve command is smaller than 50%, the degree of opening of the return valve 58 is reduced as the command value increases, to thereby increase the flow rate of the cooling air supplied to the combustion liner 22. In this embodiment, when the operation point of the booster 61 is located on the side where the pressure ratio is lower and the intake volume flow rate is higher than those on the control line Lco, and the command value of the valve command is not smaller than 50%, the degree of opening of the intake valve 57 is increased as the command value increases, to thereby increase the flow rate of the cooling air supplied to the combustion liner 22.

As shown in FIG. 3, when the operation points X1, X3 of the booster 61 have reached the control line Lco, the booster 61 enters on the anti-surge control operation. A target flow rate different from the operation condition for normal operation is given to the control device, and the first valve command RVO1 in the opening direction of the degree of opening of the return valve 58 is generated. Thus, the degree of opening indicated by the first valve command RVO1 is larger than the degree of opening indicated by the reference command BVO. Therefore, in the selection step (S5a) of the return valve command output step (S5), even when the first valve command RVO1 and the reference command BVO are received, the first valve command RVO1 that indicates a larger degree of opening is selected. In the command conversion step (S5b) of the return valve command output step (S5), the first valve command RVO1 is converted into the return valve command RVO suitable for controlling the return valve 58, and this return valve command RVO is output to the return valve 58.

Regardless of whether the command value of the valve command is smaller than 50% or not smaller than 50%, when the operation point of the booster 61 has reached the control line Lco or inside the surge region, and thus the likelihood of surging in the booster 61 has become high, the return valve command RVO based on the first valve command RVO1 from the return valve command generation unit 120 for increasing the degree of opening of the return valve 58 is output to the return valve 58. [0104]

On the other hand, even when the likelihood of surging in the booster 61 has become high, unless the first valve command SVO1 is generated in the intake valve command generation step (S4), the intake valve command SVO based on the reference command BVO is output to the intake valve 57 in the intake valve command output step (S6).

When the return valve command RVO based on the first valve command RVO1 is output to the return valve 58, the degree of opening of the return valve 58 increases, so that the flow rate of the cooling air flowing through the return line 56 increases. As a result, although the flow rate of the cooling air supplied to the combustion liner 22 does not increase, the flow rate of the cooling air passing through the booster 61 increases and the pressure ratio in the booster 61 decreases. Thus, the likelihood of surging in the booster 61 is reduced.

As has been described above, in this embodiment, when the operation points X1, X3 of the booster 61 have reached the points X2, X4 on the control line Lco or inside the surge region, and thus the likelihood of surging in the booster 61 has become high, the degree of opening of the return valve 58 is exclusively controlled so as to suppress surging.

When the load rejection command LC is output, the breaker 41 is opened under a command from the host control device 160 etc. to interrupt electrical connection between the generator 40 and the electric power system 45. Moreover, the fuel valve 26 is closed under a command from the host control device 160 etc. to interrupt fuel supply to the combustor 20. As a result, in the event of a load rejection, the discharge pressure of the air compressor 10 decreases rapidly. The intake pressure of the booster 61 also decreases rapidly as the discharge pressure of the air compressor 10 decreases rapidly. Due to the presence of the cooling air line 51, the discharge pressure of the booster 61 decreases with a delay after the decrease in the discharge pressure of the air compressor 10. Accordingly, the pressure ratio in the booster 61 temporarily increases immediately after a load rejection. Thus, in the event of a load rejection, the likelihood of surging in the booster 61 increases rapidly.

In the event of a load rejection, the likelihood of surging in the booster 61 increases, and therefore the degree of opening indicated by the first valve command RVO1 related to the return valve 58 also increases. The first valve command generation section 121 of the return valve command generation unit 120 generates the first valve command RVO1 according to various state amounts detected by the detector 64 after the load rejection. Thus, when a load rejection occurs, the first valve command generation section 121 of the return valve command generation unit 120 generates the first valve command RVO1 only after the operation points X1, X3 of the booster 61 reach the control line Lco, and generates the first valve command RVO1 ordering the return valve 58 to be forcedly opened, only after these operation points reach the surge line Ls. As a result, surging in the booster 61 can be avoided, but with poor responsiveness.

Therefore, in the return vale command generation step (S3), when the reception unit 101 receives the load rejection command LC, as described above, the second valve command generation section 131 for the return valve 58 immediately generates the second valve command RVO2 for the return valve 58 regardless of the various state amounts detected by the detector 64 (S3b: second valve command generation step). In the selection step (S5a) of the return valve command output step (S5), when the second valve command RVO2 is generated, this second valve command RVO2 is selected over other commands. In the command conversion step (S5b) of the return valve command output step (S5), the second valve command RVO2 is converted into the return valve command RVO suitable for controlling the return valve 58, and this return valve command RVO is output to the return valve 58.

In this embodiment, when the reception unit 101 receives the load rejection command LC, the return valve command RVO based on the second valve command RVO2 is output to the return valve 58 in the return valve command output step (S5), regardless of the value of the load indicated by the load command.

In the second valve command generation step (S3b) for the return valve 58, when the load rejection command LC is received, the command prompt generation part 132 immediately generates the second valve command RVO2 indicating the load rejection-adapted degree of opening that is stored in advance. For example, this load rejection-adapted degree of opening is a degree of opening at which the return valve 58 is fully open. However, the load rej ection-adapted degree of opening may be any degree of opening that is larger than the degree of opening indicated by the first valve command RVO1 at a point in time when the second valve command RVO2 is generated, and for example, the load rejection-adapted degree of opening may be a degree of opening of 90%.

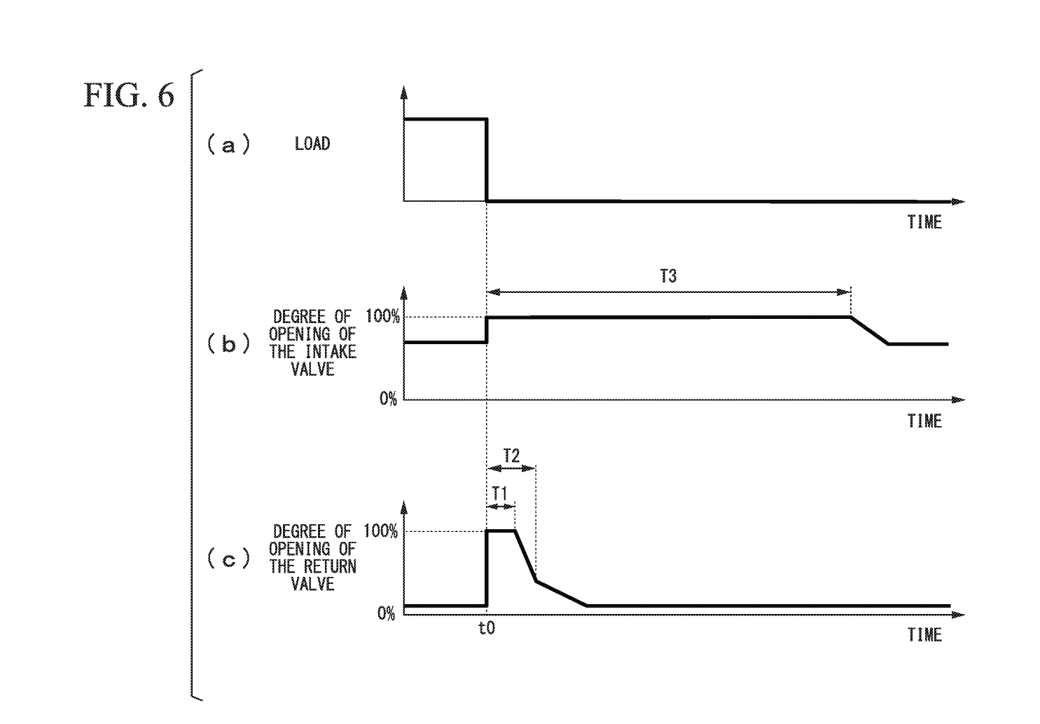

Thus, as shown in FIG. 6, when the reception unit 101 receives the load rejection command LC (t0), the degree of opening of the return valve 58 is immediately increased to the load rejection-adapted degree of opening.

In the second valve command generation step (S3b) for the return valve 58, the timer 137 counts a time from when the reception unit 101 receives the load rejection command LC. As shown in FIG. 6, the command prompt generation part 132 continuously generates the second valve command RVO2 indicating the load rejection-adapted degree of opening, from when the reception unit 101 receives the load rejection command LC (t0) until the time counted by the timer 137 reaches the first time T1

When the time counted by the timer 137 reaches the first time T1, the command prompt generation part 132 stops generating the second valve command RVO2 indicating the load rejection-adapted degree of opening. Instead, the degree-of-opening reduction command generation part 133 generates the second valve command RVO2 when the time counted by the timer 137 reaches the first time T1. Using the load rejection-adapted degree of opening and the rate of change r that is stored in the rate-of-change storage part 136, the degree-of-opening reduction command generation part 133 generates the second valve command RVO2 indicating a degree of opening of the return valve 58 at each time following the lapse of the first time T1. Specifically, the degree-of-opening reduction command generation part 133 generates the second valve command RVO2 indicating a degree of opening that decreases from the load rejection-adapted degree of opening at a constant rate of change r. This rate of change r in the closing direction is higher than the maximum rate of change in the closing direction of the degree of opening indicated by the first valve command RVO1 when the likelihood of surging is decreasing.

The degree-of-opening reduction command generation part 133 generates the second valve command RVO2 until the time counted by the timer 137 reaches the second time T2 (>T1). When the time counted by the timer 137 reaches the second time T2, the degree-of-opening reduction command generation part 133 stops generating the second valve command RVO2.

In the return valve command output step (S5), as long as the second valve command RVO2 is generated from the command prompt generation part 132 and the degree-of-opening reduction command generation part 133 of the second valve command generation section 131, the return valve command RVO based on this second valve command RVO2 is output to the return valve 58. As a result, as shown in FIG. 6, the degree of opening of the return valve 58 decreases at the constant rate of change r from when the time counted by the timer 137 reaches the first time T1 until the time reaches the second time.

The likelihood of surging in the booster 61 has become low at a point in time when the command prompt generation part 132 and the degree-of-opening reduction command generation part 133 of the second valve command generation section 131 stop generating the second valve command RVO2, i.e., at a point in time when the second time T2 has elapsed since the reception unit 101 receives the load rejection command LC. Therefore, the degree of opening indicated by the reference command BVO is larger than the degree of opening indicated by the first valve command RVO1 related to the return valve 58 at that point in time. Accordingly, in the selection step (S5a) of the return valve command output step (S5), the reference command BVO is selected from the first valve command RVO1 and the reference command BVO. In the command conversion step (S5b) of the return valve command output step (S5), the return valve command RVO based on the reference command BVO is output to the return valve 58.

From the viewpoint of suppressing surging in the booster 61 in the event of a load rejection, it would do no harm to set the degree of opening of the return valve 58 to the load rejection-adapted degree of opening after the reception unit 101 receives the load rejection command LC and to maintain this load rejection-adapted degree of opening also after that. However, when the degree of opening of the return valve 58 is set to the load rejection-adapted degree of opening, the flow rate of the cooling air supplied from the booster 61 to the combustion liner 22 through the discharge line 55 decreases, which may result in burn damage to the combustion liner 22.

In this embodiment, therefore, the degree of opening of the return valve 58 is reduced at the constant rate of change r when the first time T1 after which the likelihood of surging in the booster 61 is assumed to have become low has elapsed since the reception of the load rejection command LC. As a result, the flow rate of the cooling air supplied from the booster 61 to the combustion liner 22 through the discharge line 55 increases, so that burn damage to the combustion liner 22 can be suppressed. In particular, in this embodiment, the rate of change r in the closing direction of the return valve 58 is higher than the maximum rate of change in the closing direction of the degree of opening indicated by the first valve command RVO1 when the likelihood of surging is decreasing, so that the degree of opening of the return valve 58 decreases rapidly. Accordingly, in this embodiment, although the flow rate of the cooling air supplied to the combustion liner 22 temporarily decreases immediately after a load rejection, the flow rate of this cooling air recovers rapidly. Thus, burn damage to the combustion liner 22 can be further suppressed in this embodiment.

In the first valve command generation step (S4a) of the intake valve command generation step (S4), when the reception unit 101 receives the load rejection command LC, as described above, the first valve command generation section 141 for the intake valve 57 immediately generates the first valve command SVO1 for the intake valve 57, regardless of the various state amounts detected by the detector 64. In the selection step (S6a) of the intake valve command output step (S6), when the first valve command SVO1 is generated, this first valve command SVO1 is selected over other commands. In the command conversion step (S6b) of the intake valve command output step (S6), the first valve command SVO1 is converted into the intake valve command SVO suitable for controlling the intake valve 57, and this intake valve command SVO is output to the intake valve 57. As a result, as shown in FIG. 6, the intake valve 57 is immediately set to the load rejection-adapted degree of opening, in this case, full opening, when the reception unit 101 receives the load rejection command LC (t0). Accordingly, the volume flow rate of the cooling air flowing through the booster 61 increases rapidly. Thus, in this embodiment, surging in the event of a load rejection can be suppressed also by this action of the intake valve 57. Moreover, in this embodiment, burn damage to the combustion liner 22 can be suppressed, since the volume flow rate of the cooling air flowing through the booster 61 increases rapidly, and the volume flow rate of the cooling air supplied to the combustion liner 22 through the discharge line 55 also increases, as the intake valve 57 is forcedly opened. In particular, in this embodiment, a decrease in the flow rate of the cooling air supplied to the combustion liner 22 due to the return valve 58 being set to the load rejection-adapted degree of opening can be offset by forcedly opening the intake valve 57. Thus, in this respect, too, burn damage to the combustion liner 22 can be suppressed in this embodiment.

In the first valve command generation step (S4a) for the intake valve 57, the timer 143 counts the time from when the reception unit 101 receives the load rejection command LC. In the first valve command generation step (S4a), as shown in FIG. 6, the first valve command SVO1 indicating the load rejection-adapted degree of opening is continuously generated from when the reception unit 101 receives the load rejection command LC (t0) until the time counted by the timer 143 reaches the third time T3 (>T2). In the first valve command generation step (S4a) for the intake valve 57, generation of the first valve command SVO1 is stopped when the time counted by the timer 143 reaches the third time T3. When generation of the first valve command SVO1 is stopped in the first valve command generation step (S4a) for the intake valve 57, i.e., when the third time (T3) has elapsed since the reception unit 101 receives the load rejection command LC, the intake valve command SVO based on the reference command BVO is output to the intake valve 57 in the intake valve command output step (S6).

Thus, in this embodiment, it is possible to cool the combustion liner 22 that is a hot part while reducing the likelihood of surging in the booster 61 in the event of a load rejection.

In this embodiment, the first time T1 is adopted as the predetermined first condition under which the likelihood of surging in the booster 61 is assumed to have become low. Alternatively, a condition that the current operation point of the booster 61 determined by the state amount detected by the detector 64 enters a region where the likelihood of surging is low may be used as the first condition. Thus, the first condition may be any condition under which the likelihood of surging in the booster 61 is assumed to have become low. In this embodiment, the second time T2 is adopted as the second condition. Alternatively, a condition that the discharge flow rate detected by the discharge flowmeter 69 becomes higher than the discharge flow rate at a point in time when the first condition is met may be used as the second condition.

### Modified Example

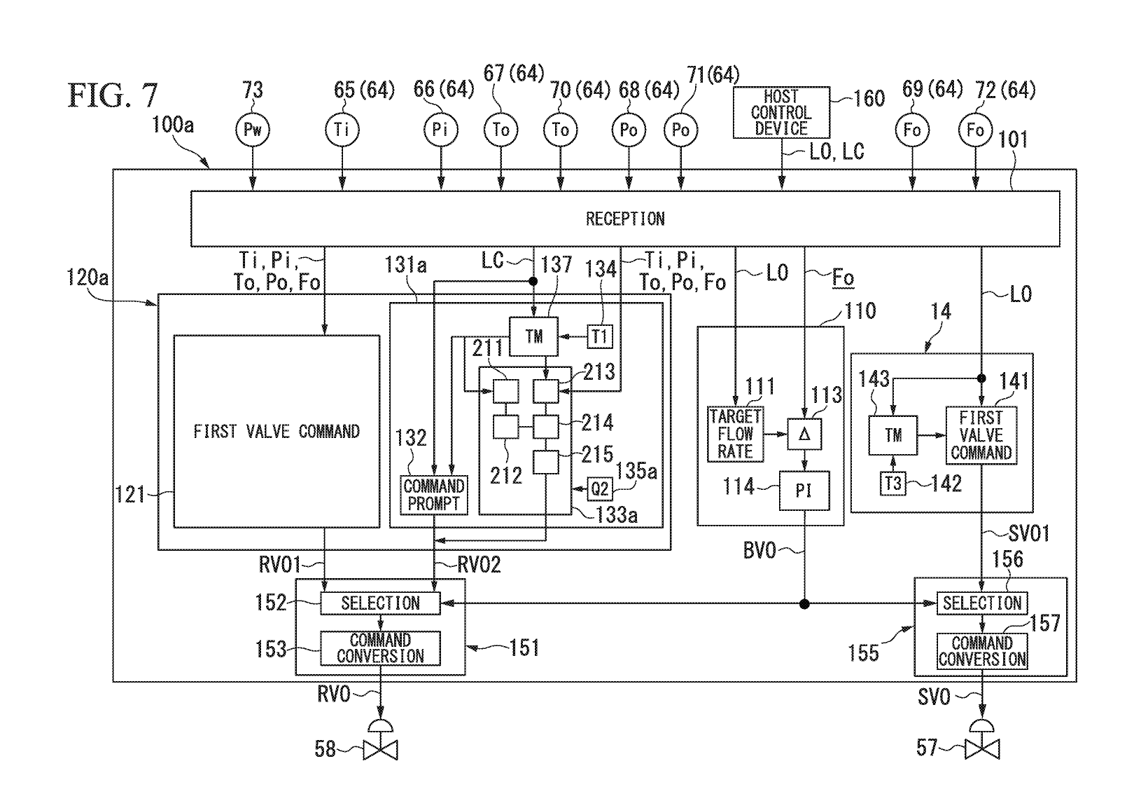

A modified example of the embodiment of the gas turbine facility described above will be described in detail with reference to FIG. 7.

Except that the configuration of a control device 100a is different from the configuration of the control device 100 of the above embodiment, the gas turbine facility of this modified example is the same as the gas turbine facility of the above embodiment. Therefore, the control device 100a of this modified example will be described below.

Like the control device 100 of the above embodiment, the control device 100a of this modified example has the reception unit 101, the reference command generation unit 110, a return valve command generation unit 120a, the intake valve command generation unit 140, the return valve command output unit 151, and the intake valve command output unit 155. Like the return valve command generation unit 120 of the above embodiment, the return valve command generation unit 120a has the first valve command generation section 121 and a second valve command generation section 131a . Like the second valve command generation section 131 of the above embodiment, the second valve command generation section 131a has the command prompt generation part 132, a degree-of-opening reduction command generation part 133a, the timer 137, the first condition storage part 134, and a second condition storage part 135a. However, the degree-of-opening reduction command generation part 133a of this modified example is different from the degree-of-opening reduction command generation part 133 of the above embodiment. Unlike the second condition storage part 135 of the above embodiment, the second condition storage part 135a of this modified example stores a predetermined discharge flow rate Q2 as the second condition.

The degree-of-opening reduction command generation part 133a of this modified example has a pressure ratio computer 211, a target flow rate generator 212, a flow rate computer 213, a flow rate deviation computer 214, and a PI controller 215. The pressure ratio computer 211 obtains a pressure ratio from the intake pressure Pi and the discharge pressure Po detected by the intake pressure indicator 66 and the discharge pressure indicator 71. The target flow rate generator 212 obtains an intake volume flow rate relative to the pressure ratio in the booster 61. The flow rate computer 213 obtains the intake volume flow rate in the booster 61 using the intake temperature Ti, the intake pressure Pi, the discharge temperature To, the discharge pressure Po, and the volume flow rate Fo detected by the discharge flowmeter 72. The flow rate deviation computer 214 obtains a deviation A of the intake volume flow rate from the target flow rate. The PI controller 215 obtains an amount of correction for the degree of opening corresponding to the amount of proportional-plus-integral action of the return valve 58 according to the flow rate deviation A, and generates the second valve command RVO2.

A proportional gain and an integral gain in the PI controller 215 of the degree-of-opening reduction command generation part 133a are different from a proportional gain and an integral gain in the PI controller 114 of the reference command generation unit 110. Specifically, the proportional gain and the integral gain in the PI controller 215 are set so that the amount of correction for the degree of opening corresponding to the amount of proportional-plus-integral action obtained by the PI controller 215 is larger than the amount of correction for the degree of opening corresponding to the amount of proportional-plus-integral action obtained by the PI controller 114 of the reference command generation unit 110.

Also in this modified example, the degree-of-opening reduction command generation part 133a generates the second valve command RVO2 when the time counted by the timer 137 reaches the first time T1. The degree of opening of the return valve 58 at a point in time when the time counted by the timer 137 reaches the first time T1 is the load rejection-adapted degree of opening. The likelihood of surging in the booster 61 has become low at the point in time when the time counted by the timer 137 reaches the first time T1. Therefore, the degree-of-opening reduction command generation part 133a generates the second valve command RVO2 indicating a degree of opening that decreases gradually as time elapses. As in the above embodiment, the return valve command output unit 151 outputs, to the return valve 58, the return valve command RVO based on the second valve command RVO2 from the command prompt generation part 132 and the degree-of-opening reduction command generation part 133a.

In this modified example, the flow rate deviation A obtained by the flow rate deviation computer 214 changes when the target flow rate obtained by the target flow rate generator 212 and/or the intake volume flow rate obtained by the flow rate computer 213 changes after a lapse of the first time T1. When this flow rate deviation Δ changes, the amount of correction for the degree of opening corresponding to the amount of proportional-plus-integral action of the return valve 58 obtained by the PI controller 215 also changes, and thus the rate of change in the degree of opening of the return valve 58 after a lapse of the first time T1 does not remain constant. Accordingly, in this modified example, in some cases the flow rate of the cooling air sent to the hot part may not be sufficient to cool the hot part, even when the second time T2 has elapsed since the reception unit 101 receives the load rejection command LC as in the above embodiment. In other cases, conversely, the flow rate of the cooling air sent to the hot part may be sufficient to cool the hot part, even before the second time T2 has elapsed since the reception unit 101 receives the load rejection command LC. In this modified example, therefore, the predetermined discharge flow rate Q2 that is sufficient to cool the hot part is stored as the second condition in the second condition storage part 135a.

The degree-of-opening reduction command generation part 133a stops generating the second valve command RVO2 when the discharge flow rate detected by the discharge flowmeter 72 reaches the discharge flow rate Q2 stored in the second condition storage part 135a. As in the above embodiment, when the degree-of-opening reduction command generation part 133a stops generating the second valve command RVO2, the return valve command output unit 151 outputs the return valve command RVO based on the reference command BVO to the return valve 58.

Thus, also in this modified example, the degree of opening of the return valve 58 decreases when the first time T1 after which the likelihood of surging in the booster 61 is assumed to have become low has elapsed since the reception of the load rejection command LC. As a result, also in this modified example, although the flow rate of the cooling air supplied from the booster 61 to the combustion liner 22 through the discharge line 55 decreases after a load rejection, the flow rate of this cooling air increases after a lapse of the first time T1, so that burn damage to the combustion liner 22 can be suppressed.

As described above, the proportional gain and the integral gain in the PI controller 215 of the degree-of-opening reduction command generation part 133a are set so that the amount of correction for the degree of opening corresponding to the amount of proportional-plus-integral action obtained by the PI controller 215 is larger than the amount of correction for the degree of opening corresponding to the amount of proportional-plus-integral action obtained by the PI controller 114 of the reference command generation unit 110. Accordingly, the rate of change in the closing direction of the return valve 58 specified by the second valve command RVO2 from the degree-of-opening reduction command generation part 133a is higher than the maximum rate of change in the closing direction of the degree of opening specified by the reference command BVO when the likelihood of surging is decreasing. Thus, also in this modified example, the degree of opening of the return valve 58 decreases rapidly after a lapse of the first time T1 as in the above embodiment. As a result, also in this modified example, the flow rate of the cooling air that has decreased immediately after a load rejection recovers rapidly.

### Other Modified Examples

In the above embodiment and modified example, the control device 100 or 100a and the host control device 160 are separate from each other, but these control devices may be integrated.

The cooling system 50 of the above embodiment and modified example sends cooling air to the combustion liner 22 as a hot part. However, the cooling system 50 may also send cooling air to any hot parts other than the combustion liner 22. For example, the cooling system 50 may send cooling air to the blades 35 or the vanes 39 of the turbine 30.

### INDUSTRIAL APPLICABILITY

One aspect of the present invention makes it possible to reduce the likelihood of surging in a booster in the event of a load rejection. Thus, this aspect of the present invention makes it possible to send cooling air to a hot part and cool this hot part even in the event of a load rejection.

### REFERENCE SIGNS LIST

1 Gas turbine
2 Gas turbine rotor
6 Intermediate casing
7 Gas turbine casing
10 Air compressor
12 Compressor rotor
17 Compressor casing
20 Combustor
21 Fuel injector
22 Combustion liner
25 Fuel line
26 Fuel valve
30 Turbine
31 Combustion gas flow passage
32 Turbine rotor
33 Rotor shaft
34 Blade row
35 Blade
37 Turbine casing
38 Vane row
39 Vane
40 Generator
41 Breaker
50 Gas turbine cooling system
51 Cooling air line
52 Intake air line
53 Uncooled intake air line
54 Cooled intake air line
55 Discharge line
56 Return line
57 Intake valve
58 Return valve
61 Booster
63 Cooler
64 Detector
65 Intake temperature indicator
66 Intake pressure indicator
67, 70 Discharge temperature indicator
68, 71 Discharge pressure indicator
69, 72 Discharge flowmeter
73 Output meter
100, 100a Control device
101 Reception unit
110 Reference command generation unit
120, 120a Return valve command generation unit
121 First valve command generation section
131, 131a Second valve command generation section
132 Command prompt generation part
133, 133a Degree-of-opening reduction command generation part
137 Timer
140 Intake valve command generation unit
141 First valve command generation section
143 Timer
151 Return valve command output unit
152, 156 Selection section
153, 157 Command conversion section
155 Intake valve command output unit
160 Host control device

1. A gas turbine cooling system comprising:
a cooling air line that guides compressed air compressed by an air compressor of a gas turbine to a hot part coming in contact with combustion gas in the gas turbine;
a cooler that cools the compressed air in the cooling air line to produce cooling air;
a booster that pressurizes the cooling air in the cooling air line;
a return line that returns the cooling air in a discharge line that is a line of the cooling air line located on a side of the hot part from the booster, to an intake air line that is a line of the cooling air line located on a side of the air compressor from the booster;
a return valve that is provided in the return line and adjusts a flow rate of the cooling air flowing through the return line;
a detector that detects a state amount of the cooling air flowing through the intake air line and a state amount of the cooling air flowing through the discharge line; and
a control device that controls a degree of opening of the return valve, the control device including:
a reception unit that receives a load rejection command indicating a load rejection of the gas turbine;
a first valve command generation section that generates a first valve command indicating a degree of opening of the return valve according to the state amount detected by the detector;
a second valve command generation section that, when the reception unit receives the load rejection command, generates as a second valve command a valve command ordering the degree of opening of the return valve to be forcedly increased to a predetermined load rejection-adapted degree of opening that is not smaller than a degree of opening indicated by the first valve command, regardless of the state amount detected by the detector; and
a return valve command output unit that outputs a return valve command based on the second valve command to the return valve when the second valve command generation section is generating the second valve command, and outputs a return valve command based on the first valve command according to a state of the gas turbine to the return valve when the second valve command generation section is not generating the second valve command.

2. The gas turbine cooling system according to claim 1, wherein the load rejection-adapted degree of opening is a degree of opening at which the return valve is fully open.

3. The gas turbine cooling system according to claim 1, wherein, when the reception unit receives the load rejection command, the second valve command generation section generates as the second valve command a valve command ordering the load rejection-adapted degree of opening to be maintained until a predetermined condition under which a likelihood of surging in the booster is assumed to have become low is met.

4. The gas turbine cooling system according to claim 3, wherein, when the predetermined condition is met, the second valve command generation section generates as the second valve command a valve command ordering the degree of opening of the return valve to be reduced from the load rejection-adapted degree of opening.

5. The gas turbine cooling system according to claim 4, wherein
the first valve command generation section generates the first valve command indicating an increasing degree of opening of the return valve when the state amount detected by the detector indicates that the likelihood of surging is increasing, and generates the first valve command indicating a decreasing degree of opening of the return valve when the state amount detected by the detector indicates that the likelihood of surging is decreasing, and
a rate of change in a closing direction of the degree of opening indicated by the second valve command when the predetermined condition is met is higher than a maximum rate of change in the closing direction of the degree of opening indicated by the first valve command when the likelihood of surging is decreasing.

6. The gas turbine cooling system according to claim 4, wherein the rate of change in the degree of opening indicated by the second valve command when the predetermined condition is met is a predetermined rate of change.

7. The gas turbine cooling system according to claim 4, wherein, when the predetermined condition is met, the second valve command generation section generates as the second valve command a valve command indicating a degree of opening that is determined according to the state amount detected by the detector.

8. The gas turbine cooling system according to claim 4, wherein the second valve command generation section stops generating the second valve command when a second condition is met after a first condition that is the predetermined condition is met.

9. The gas turbine cooling system according to claim 1, further comprising an intake valve that is provided in the intake air line and adjusts a flow rate of the cooling air flowing through the intake air line, wherein
the control device includes:
an intake valve command generation unit that, when the reception unit receives the load rejection command, generates a first valve command ordering a degree of opening of the intake valve to be forcedly increased to a predetermined load rejection-adapted degree of opening, regardless of the state amount detected by the detector; and
an intake valve command output unit that outputs, to the intake valve, an intake valve command based on the first valve command generated by the intake valve command generation unit.

10. The gas turbine cooling system according to claim 9, wherein the load rej ection-adapted degree of opening indicated by the first valve command generated by the intake valve command generation unit is a degree of opening at which the intake valve is fully open.

11. The gas turbine cooling system according to claim 1, wherein
the control device includes a reference command generation unit that generates a reference command indicating a degree of opening that changes with a positive correlation with a change in a load applied to the gas turbine,
when the likelihood of surging in the booster has become high, the first valve command generation section generates as the first valve command a command indicating a degree of opening that is larger than the degree of opening indicated by the reference command, according to the state amount detected by the detector,
the return valve command output unit has a selection section that selects one command of the first valve command, the second valve command, and the reference command related to the return valve, and a command conversion section that converts the one command selected by the selection section into a return valve command suitable for controlling the return valve and outputs the return valve command to the return valve,
when the second valve command, and the first valve command or the reference command related to the return valve, are input, the selection section selects the second valve command, and when the second valve command is not input and the first valve command and the reference command are input, the selection section selects one of the commands indicating a larger degree of opening, and
in a case where the one command selected by the selection section is the reference command, when the load is smaller than a predetermined value, the command conversion section converts the reference command into a return valve command indicating a degree of opening of the return valve that changes with a negative correlation with a change in the load, and when the load is not smaller than the predetermined value, the command conversion section converts the reference command into a return valve command indicating a degree of opening that is constant regardless of a change in the load.

12. The gas turbine cooling system according to claim 9,
the control device includes a reference command generation unit that generates a reference command indicating a degree of opening that changes with a positive correlation with a change in a load applied to the gas turbine,
when the likelihood of surging in the booster has become high, the first valve command generation section generates as the first valve command a command indicating a degree of opening that is larger than the degree of opening indicated by the reference command, according to the state amount detected by the detector,
the return valve command output unit has a selection section that selects one command of the first valve command, the second valve command, and the reference command related to the return valve, and a command conversion section that converts the one command selected by the selection section into a return valve command suitable for controlling the return valve and outputs the return valve command to the return valve,
when the second valve command related to the return valve and the first valve command or the reference command related to the return valve are input, the selection section selects the second valve command, and when the second valve command is not input and the first valve command and the reference command are input, the selection section selects one of the commands indicating a larger degree of opening,
in a case where the one command selected by the selection section is the reference command, when the load is smaller than a predetermined value, the command conversion section converts the reference command into a return valve command indicating a degree of opening of the return valve that changes with a negative correlation with a change in the load, and when the load is not smaller than the predetermined value, the command conversion section converts the reference command into a return valve command indicating a degree of opening that is constant regardless of a change in the load,
the intake valve command output unit has a selection section that selects one command of the first valve command and the reference command related to the intake valve, and a command conversion section that converts the one command selected by the selection section of the intake valve command output unit into an intake valve command suitable for controlling the intake valve and outputs the intake valve command to the intake valve,
when the first valve command and the reference command related to the intake valve are input, the selection section of the intake valve command output unit selects one of the commands indicating a larger degree of opening, and
in a case where the one command selected by the selection section of the intake valve command output unit is the reference command, when the load is smaller than the predetermined value, the command conversion section of the intake valve command output unit converts the reference command into an intake valve command indicating a degree of opening that is constant regardless of a change in the load, and when the load is not smaller than the predetermined value, the command conversion section converts the reference command into an intake valve command indicating a degree of opening that changes with a positive correlation with a change in the load.

13. The gas turbine cooling system according to claim 9, wherein the intake valve command generation unit stops generating the first valve command related to the intake valve when a condition under which the hot part is assumed to have returned to a sufficiently cooled state is met after a condition under which the likelihood of surging in the booster is assumed to have become low is met.

14. A gas turbine facility comprising:
the gas turbine cooling system according to claim 1; and
the gas turbine.

15. A control method of a gas turbine cooling system including: a cooling air line that guides compressed air compressed by an air compressor of a gas turbine to a hot part coming in contact with combustion gas in the gas turbine; a cooler that cools the compressed air in the cooling air line to produce cooling air; a booster that pressurizes the cooling air in the cooling air line; a return line that returns the cooling air in a discharge line that is a line of the cooling air line located on a side of the hot part from the booster, to an intake air line that is a line of the cooling air line located on a side of the air compressor from the booster; and a return valve that is provided in the return line and adjusts a flow rate of the cooling air flowing through the return line,
the control method comprising:
a detection step of detecting a state amount of the cooling air flowing through the intake air line and a state amount of the cooling air flowing through the discharge line;
a reception step of receiving a load rejection command indicating a load rejection of the gas turbine;
a first valve command generation step of generating a first valve command indicating a degree of opening of the return valve according to the state amount detected in the detection step;
a second valve command generation step of, when the load rejection command is received in the reception step, generating as a second valve command a valve command ordering the degree of opening of the return valve to be forcedly increased to a predetermined load rej ection-adapted degree of opening that is not smaller than the degree of opening indicated by the first valve command, regardless of the state amount detected in the detection step; and
a return valve command output step of outputting a return valve command based on the second valve command to the return valve when the second valve command is being generated in the second valve command generation step, and outputting a return valve command based on the first valve command to the return valve, according to a state of the gas turbine, when the second valve command is not being generated in the second valve command generation step.

16. The control method of a gas turbine cooling system according to claim 15, wherein the load rejection-adapted degree of opening is a degree of opening at which the return valve is fully open.

17. The control method of a gas turbine cooling system according to claim 15 wherein, in the second valve command generation step, when the load rejection command is received in the reception step, a valve command ordering the load rejection-adapted degree of opening to be maintained until a predetermined condition under which a likelihood of surging in the booster is assumed to have become low is met is generated as the second valve command.

18. The control method of a gas turbine cooling system according to claim 17, wherein, in the second valve command generation step, when the predetermined condition is met, a valve command ordering the degree of opening of the return valve to be reduced from the load rejection-adapted degree of opening is generated as the second valve command.

19. The control method of a gas turbine cooling system according to claim 18, wherein
in the first valve command generation step, the first valve command indicating an increasing degree of opening of the return valve is generated when the state amount detected in the detection step indicates that the likelihood of surging is increasing, and the first valve command indicating a decreasing degree of opening of the return valve is generated when the state amount detected in the detection step indicates that the likelihood of surging is decreasing, and
a rate of change in a closing direction of the degree of opening indicated by the second valve command when the predetermined condition is met is higher than a maximum rate of change in the closing direction of the degree of opening indicated by the first valve command when the likelihood of surging is decreasing.

20. The control method of a gas turbine cooling system according to claim 18, wherein the rate of change in the degree of opening indicated by the second valve command when the predetermined condition is met is a predetermined rate of change.

21. The control method of a gas turbine cooling system according to claim 18, wherein, in the second valve command generation step, when the predetermined condition is met, a valve command indicating a degree of opening that is determined according to the state amount detected in the detection step is generated as the second valve command.

22. The control method of a gas turbine cooling system according to claim 18, wherein, in the second valve command generation step, generation of the second valve command is stopped when a second condition is met after a first condition that is the predetermined condition is met.

23. The control method of a gas turbine cooling system according to claim 15, wherein
the gas turbine cooling system includes an intake valve that is provided in the intake air line and adjusts a flow rate of the cooling air flowing through the intake air line, and
the control method further comprises:
an intake valve command generation step of, when the load rejection command is received in the reception step, generating a first valve command ordering the degree of opening of the intake valve to be forcedly increased to a predetermined load rejection-adapted degree of opening, regardless of the state amount detected in the detection step; and
an intake valve command output step of outputting, to the intake valve, an intake valve command based on the first valve command generated in the intake valve command generation step.

24. The control method of a gas turbine cooling system according to claim 23, wherein the load rej ection-adapted degree of opening indicated by the first valve command generated in the intake valve command generation step is a degree of opening at which the intake valve is fully open.

25. The control method of a gas turbine cooling system according to claim 15, further comprising a reference command generation step of generating a reference command indicating a degree of opening that changes with a positive correlation with a change in a load applied to the gas turbine, wherein
in the first valve command generation step, when the likelihood of surging in the booster has become high, a command indicating a degree of opening that is larger than the degree of opening indicated by the reference command is generated as the first valve command related to the return valve, according to the state amount detected in the detection step,
the return valve command output step includes a selection step of selecting one command of the first valve command, the second valve command, and the reference command related to the return valve, and a command conversion step of converting the one command selected in the selection step into a return valve command suitable for controlling the return valve and outputting the return valve command to the return valve,
in the selection step, when the second valve command, and the first valve command or the reference command related to the return valve, are input, the second valve command is selected, and when the second valve command is not input and the first valve command and the reference command are input, one of the commands indicating a larger degree of opening is selected, and
in the command conversion step, in a case where the one command selected in the selection step is the reference command, when the load is smaller than a predetermined value, the reference command is converted into a return valve command indicating a degree of opening of the return valve that changes with a negative correlation with a change in the load, and when the load is not smaller than the predetermined value, the reference command is converted into a return valve command indicating a degree of opening that is constant regardless of a change in the load.

26. The control method of a gas turbine cooling system according to claim 23, further comprising a reference command generation step of generating a reference command indicating a degree of opening that changes with a positive correlation with a change in a load applied to the gas turbine, wherein
in the first valve command generation step, when the likelihood of surging in the booster has become high, a command indicating a degree of opening that is larger than the degree of opening indicated by the reference command is generated as the first valve command related to the return valve, according to the state amount detected in the detection step,
the return valve command output step includes a selection step of selecting one command of the first valve command, the second valve command, and the reference command related to the return valve, and a command conversion step of converting the one command selected in the selection step into a return valve command suitable for controlling the return valve and outputting the return valve command to the return valve,
in the selection step, when the second valve command, and the first valve command or the reference command related to the return valve, are input, the second valve command is selected, and when the second valve command is not input and the first valve command and the reference command are input, one of the commands indicating a larger degree of opening is selected,
in the command conversion step, in a case where the one command selected in the selection step is the reference command, when the load is smaller than a predetermined value, the reference command is converted into a return valve command indicating a degree of opening of the return valve that changes with a negative correlation with a change in the load, and when the load is not smaller than the predetermined value, the reference command is converted into a return valve command indicating a degree of opening that is constant regardless of a change in the load,
the intake valve command output step includes a selection step of selecting one command of the first valve command and the reference command related to the intake valve, and a command conversion step of converting the one command selected in the selection step of the intake valve command output step into an intake valve command suitable for controlling the intake valve and outputting the intake valve command to the intake valve,
in the selection step of the intake valve command output step, when the first valve command and the reference command related to the intake valve are input, one of the commands indicating a larger degree of opening is selected, and
in the command conversion step of the intake valve command output step, in a case where the one command selected in the selection step of the intake valve command output step is the reference command, when the load is smaller than the predetermined value, the reference command is converted into an intake valve command indicating a degree of opening that is constant regardless of a change in the load, and when the load is not smaller than the predetermined value, the reference command is converted into an intake valve command indicating a degree of opening that changes with a positive correlation with a change in the load.

27. The control method of gas turbine cooling system according to claim 26, wherein, in the intake valve command generation step, generation of the first valve command related to the intake valve is stopped when a condition under which the hot part is assumed to have returned to a sufficiently cooled state is met after a condition under which the likelihood of surging in the booster is assumed to have become low is met.
